(19) United States
(12) Patent Application Publication
(10) Pub. No.: US 2014/0114674 A1
(43) Pub. Date: Apr. 24, 2014

(54) Health Insurance Plan Comparison Tool

(71) Applicants: Robert M. Krughoff, Washington, DC (US); Robert M. Ellis, Washington, DC (US); Phyo Win, Rockville, MD (US); Walton J. Francis, Fairfax, VA (US)

(72) Inventors: Robert M. Krughoff, Washington, DC (US); Robert M. Ellis, Washington, DC (US); Phyo Win, Rockville, MD (US); Walton J. Francis, Fairfax, VA (US)

(21) Appl. No.: 13/657,758

(22) Filed: Oct. 22, 2012

(51) Int. Cl. G06Q 30/06; G06F 19/00

(52) U.S. Cl. CPC G06Q 30/0629; G06F 19/328
USPC 705/2

(57) ABSTRACT

A tool comparing different health insurance plans. A User can review a plurality of health plans for likely cost, quality, and provider availability. The results are arranged in a table according to selectable criteria, such as actuarially estimated total costs (premiums plus actuarial estimate of out-of-pocket). Actuarial cost estimates are used with one or more of the following: personalized summary quality measures produced by the User's applying personal weights to different aspects of quality; availability of User-selected health care providers indicating if these providers participate in each listed plan; information on the costs and quality of available health care providers; ability for User to adjust actuarial estimates based on User-predicted health care conditions, procedures, and products; and ability for User to adjust premiums based on User preference as to whether to accept the full available subsidy. User can sort, filter, and select plans based on displayed features.

### BACKGROUND OF THE INVENTION

1. Field of the Invention

This invention is generally related to a comparison tool that assists a User to select among a plurality of insurance plans or selections, and in one embodiment is more particularly related to a comparison tool to help Users, such as consumers or employers, to make different kinds of comparisons and to add their own preference and weights, in comparing cost, quality, provider availability, and other features of health insurance plans.

2. Description of the Prior Art

There is a constant need to be able to rate or rank in order available insurance plans based on cost, quality, and other considerations. There is also a need to provide a comprehensive rating system for insurance plans which system is simple for a User to understand and use, and at the same time permits the User to add subjective inputs and criteria.

In the health care and health insurance field, there do exist several methods for comparing health plans. One such method was developed by Walton Francis and the editors of Consumers' CHECKBOOK. This system, CHECKBOOK's Guide to Health Plans for Federal Employees (hereafter termed “Guide”), started in 1979 as a paper publication. Since 2000, it has been available online as well, allowing Federal employees and retirees to compare all health insurance plans (currently about 200) available in the Federal Employees Health Benefits Program (FEHBP). Some of its methods have been copied since then, most notably in the Medicare Plan Finder sponsored by the Centers for Medicare and Medicaid Services, starting in 2005. Historically, the central feature of the Guide has been that it provides information on actuarial estimates of the relative cost (health insurance premium plus out-of-pocket expenses) of all plans on the Federal employee “exchange” in order to let consumers compare plans to find those that best meet their needs and preferences.

There are a number of health plan “exchanges” in operation today, including those of Medicare, CalPERS, Massachusetts, and Healthcare.gov (an HHS system comparing private plans available to individuals and small business employers). All of them provide some form of plan comparison tool. Most of the current “exchanges”—the Massachusetts Connector, the Federal Healthcare.gov website, the Utah Health Exchange, and others—fall far short when it comes to providing a plan comparison tool that addresses consumer needs, and fail to provide the actuarial value cost comparison used in the Guide.

Most existing health plan comparison tools contain a list of plans, premium information, and some advisory features such as a display of summary cost sharing information for each plan or access to a plan brochure (see California Public Employees Retirement System, Center for Medicare and Medicaid Services, Department of Health and Human Services, Massachusetts HealthConnector, Office of Personnel Management, and PlanSmartChoice). For example, all of them contain detailed comparisons of plans' premiums and cost sharing parameters, such as copayments for physician visits. Premiums taken alone give a highly incomplete picture of cost because it does not take into account all “types” of costs (such as co-pay and deductibles). The detailed cost sharing information may be of interest to some fraction of User, but as shown by Consumers Union's research, the information is unintelligible to many Users and of little or no use to the great majority of Users.

In fact, recent consumer research by Consumers Union has shown that the kinds of information provided by existing exchanges on deductibles, copayments, and coinsurance for each health insurance plan participating in an exchange present difficulties so great “that the vast majority of consumers are essentially being asked to buy a very expensive product—critical to their health—while blindfolded” (Consumers Union).

In purchasing health insurance, there are two general categories of cost that must be considered: the premium cost, which is often known before choosing a health plan, and the “out-of-pocket costs” (OOP cost), which is the sum of costs the enrollee ultimately will pay (or can be predicted to pay) for deductibles, coinsurance, copayments, and exclusions, as subject to limits on maximum cost exposure (most notably, “catastrophic cost” limits on the most an enrollee and family will have to pay in any one year).

There are other tools disclosed in the prior art that claim to help in plan choice, and sometimes use similar descriptions or even partially useful techniques, but that largely or totally fail to provide the kind of information and advice that is genuinely useful to consumers:
a. For example, the U.S. Pat. No. 7,958,002 discloses a tool to allow employers to compare the cost and value of plans with regard to effects on employee absenteeism and productivity. The Bost patent describes a process by which an employer can look at different plans with regard to how well they control the incidence and cost of such conditions as chicken pox, depression, asthma, and maternity. The tool also permits the calculation of the value to the employer of reduced days absent from work for each such condition or disease as its method of calculating plan cost or savings relative to other plans. However, there is no disclosure in Bost for making estimates of plan differences on many important factors—for example, claims handling and other aspects of customer service. In addition, there is no described applicability allowing consumers to compare either the out-of-pocket costs or the availability and quality of providers in plans. For example, although Bost mentions using a “methodology” for estimating “costs to employees,” it nowhere discloses a method for an actuarial value or other calculation method for obtaining such costs. It fails to disclose a method for employers to choose a health plan for their employees and fails to disclose calculations based on deductible, coinsurance, or copays under each plan to calculate out-of-pocket (OOP) costs either for overall actuarial value or for particular conditions or diseases. In fact, the concepts of “out-of-pocket,” “deductible,” and “coinsurance” are not disclosed in Bost. It is impossible to calculate either overall or disease-specific costs to consumers absent a method that specifically takes into account such factors as deductibles and coinsurance.
b. Several tools exist to serve individual consumers and provide what can be described as a “known-usage” calculator model of predicting insurance costs. Under the “known-usage calculator” model, the User inputs all or most of the health care system uses the User expects to have in the coming year (e.g. the number of drug prescriptions, the number of doctor visits, and the number of hospital visits)—and then the comparison tool estimates a typical provider charge for each of these uses and purports to calculate how much the User would have to spend out of pocket under each plan as the member's share of those predicted expenses. Alternatively, a known-usage calculator model may ask the User to predict specific conditions the User will have in the coming year and the model estimates the health system uses that the User will have in connection with those conditions and the charges for those uses. “Known-usage” models have some intuitive appeal, and are the common approach for deciding how much to put into a Flexible Spending Account, but they fall far short of being sufficient for selecting insurance plans. The fundamental problem with such a known-usage approach is that a key reason for insurance is to protect the policyholder against the cost of what the policyholder cannot predict—a serious accident, new disease, or new treatment plan. With the known-usage calculator approach, the out-of-pocket cost estimates don't reflect those unexpected costs. Considering them could dramatically affect the relative ranking of plans. Another problem is that with even one moderately complex medical condition, or in a family with several members with different conditions, it is time-consuming and often impossible for the User to estimate future usage by type of expense. For example, very few consumers know or can readily find out the likely implications of maternity or of a heart attack in terms of actual numbers of visits to the physicians and other providers. Even if the number of visits were known, the “known-usage calculator” models, without exception, fail to estimate accurately the out-of-pocket costs for maternity, heart attack or any other specific condition under any insurance plan.
c. The Center for Medicare and Medicaid Services Plan Compare Tool uses a variant of the known-usage approach that is drug treatment-specific. That tool estimates likely prescription drug costs to consumers by having the consumer enter each current prescription. The tool then calculates how well each Medicare Prescription Drug Plan will cover the cost of each drug, and then calculates the annual OOP for all these drugs added up together. This tool has important value in helping consumers find a plan that covers their expensive known drugs. But it has the inherent flaw of all known-usage tools in that it does not anticipate unforeseen drug costs—for example, if the consumer newly requires chemotherapy for a new cancer, expensive drugs for a new condition such as rheumatoid arthritis, or otherwise faces unforeseen cost increases or decreases (e.g., an expensive drug discontinued as the disease progresses). It is also, as a practical matter, unusable by families with several members taking multiple drugs. Even Medicare enrollees, who are all individually enrolled, find it difficult to enter all the needed data on drug names and dosages, when getting rapidly to useful results. This Center for Medicare and Medicaid Services tool has another major problem. It cannot be accurate unless it covers essentially every drug, every dosage level, every generic equivalent, every therapeutically equivalent drug, and the prices for each of these in each of hundreds of plans. The Center for Medicare and Medicaid Services requires participating Part D plans to spend millions of dollars annually to submit and verify these data. CMS spends additional millions to create the algorithms by which plans are compared for OOP levels. These costs would be somewhat lower in any individual State health insurance Exchange if other states bought the “same package,” but would always be very substantial.
d. There is direct research evidence as to the failure of “known-usage” tools to lead to rational plan choices. Among all the types of medical insurance expenditures, prescription drugs have the highest level of persistence from year to year. A consumer taking a statin drug this year, for example, is highly likely to continue the drug next year. In Abaluck, Jason and Gruber, Jonathan, “Heterogeneity in Choice Inconsistencies among the Elderly Evidence from Prescription Drug Plan Choice,” American Economic Review, May 2011 (hereinafter “Abaluck and Gruber”), the authors examined the prescription drug plan choices of Medicare consumers, all of whom had access both to Medicare's Plan Finder tool and, of course, their own personal knowledge of drugs they were taking, the plan they were in, and the costs they faced. These researchers found that only about 12 percent of these consumers chose the lowest cost plan (premium plus OOP for drugs actually taken) and that “the typical elder could save $296, or 30.1 percent of his or her total Part D costs by choosing the lowest cost plan rather than the plan that he or she did choose.” Of course, there are many reasons that an enrollee might choose a more costly plan, such as pharmacy convenience or a better catastrophic protection. But by far the most obvious reason is that consumers do not have perfect knowledge of future costs. Abaluck and Gruber also found that consumers are irrationally far more sensitive to dollar differences in premiums than to dollar differences in OOP, a factor noted in other studies and one that the present invention overcomes in its presentation methods.
e. Some believe that the “metal” level calculations for plans offered in each State Exchange under the Affordable Care Act, to be performed by highly skilled actuaries, solve the insurance value, or actuarial value, problem. This is superficially plausible, but false. The basic problem is that the Affordable Care Act necessarily focuses on aggregate issues and aggregate calculations. The Bronze level plans, for example, have to have an overall actuarial value in most cases equal to approximately 60 percent of the expected costs for covered benefits for the population. But this value applies across the entire range of consumers who will use Exchanges: healthy and single 20 year olds, young couples about to have their first child, large families headed by a 60 year old with an expensive preexisting condition, etc. The same applies at each Metal level. But the overall value that is accurate for the population as a whole is necessarily inaccurate for each subset of the population whose prior (Bayesian) probability of expense is different. In the real world, the plan that is the best value for the 50 year old overweight diabetic is unlikely to be the best value for the 25 year old heart-healthy athlete. As CHECKBOOK's Guide points out, children's expenses average about $1,800 a year and an adult below 55 has expenses averaging $5,000 a year (those over 65 have average medical and dental care expenses, NOT including long term care, of about $15,000 a year). Likewise, those with higher drug expenses and lower hospital expenses, or vice-versa, will not derive the same value from a plan that is generous on drugs but has high cost sharing for hospital expenses.
f. A central feature for the entire duration of the CHECKBOOK's Guide to Health Plans for Federal Employees existence is that it provides Users the true insurance value of each plan—a single dollar-amount estimate of average total expected cost under each plan (premium plus out-of-pocket costs after any tax and subsidy effects) for households similar to the User in age, family composition, and possibly other characteristics like self-reported health status—based on actuarial analysis of data showing the probability of different total amounts and types of expenses in the population. The tool according to the present invention goes beyond just a description of deductibles; coinsurance levels, etc., and goes beyond a mere dollar-amount out-of-pocket estimate based only on expenses the User can predict.
   The Guide has also shown Users: (1) possible expenses of each plan in very good years and very bad years, including years with the maximum possible out-of-pocket expenses, and the likelihood of having such years; (2) Any coverage gaps and any unusual benefit strengths—and why they matter; (3) how plans compare on specific measures of service quality; (4) how plans compare on cost-sharing parameters and coverage features (for example, deductibles and coinsurance); (5) text explanations of key factors important in plan selection (such as the differences between HMOs and fee-for-service plans) and in-depth advice; and (6) fast arrival at comparison results. All these features have been central to the Guide for more than 10 years. The Guide also provides online (7) access to plan brochures.

Thus, there is a need for a comprehensive comparison tool that affords the User the ability to add inputs and to make realistic, yet variable, choices among a large number of health insurance plans that have various different features. There is also a need that a comprehensive comparison tool be easily used and understood by the User

### SUMMARY OF THE INVENTION

The present invention provides an insurance plan comparison tool that goes beyond what is found in other health insurance plan comparison tools. It reliably, rapidly, and accurately (to practical levels) guides consumers to health plans that best meet their needs and preferences for low-cost, responsive, accessible, and high-quality health insurance coverage. The present invention provides new and improved features in addition to the features that previously existed in CHECKBOOK's Guide to Health Plans for Federal Employees.

A health plan comparison tool according to the present invention supplements many of the prior art features and embodies features that are new, including allowing Users to see an all-plan provider directory for plans available to the User so consumers can easily see which plan networks include doctors they wish to have access to.

The present invention provides a provider directory for the tool User's region showing quality measures for available doctors and possibly other providers. It shows how insurance plans compare on care and service quality measures, which can include plan ratings by members, quality and reach of plan-provided health improvement programs, accessibility of high-quality providers, measures of whether members get recommended tests and treatments, measures of member outcomes, frequency of member complaints, and other measures—allowing the User to produce a personalized summary score for each plan by giving personal weights to the quality dimensions of greatest personal interest. The present invention shows possible expenses in each plan in very good years and very bad years (including years when the User's expenses exceed plan out-of-pocket limits) and the likelihood of having such years. It also shows the likely effects on out-of-pocket costs of known overall health status—for example, whether the User is in poor, good, or excellent health status health status as reported by the User. It shows the likely effects on out-of-pocket costs of known expensive future conditions, procedures or products—for example, an expensive operation or a pregnancy. The present invention uses a simple comparison of the available plan choices followed by easy opportunities to filter and narrow—not encouraging Users to narrow their choices with preliminary questions before they have seen the range of choices and what they might give up by ruling out options. (Examples of such preliminary questions might include: Will you consider an HMO, and what is the highest deductible you will accept?) In addition, the present invention in one embodiment includes User help tools such as clear, simple explanations in video and audio guides of the many displayed health plan features. These help tools de-mystify insurance shopping and decisions even for unsophisticated Users.

A principal feature of the present invention is that it permits the User to make excellent, personalized plan choices in the short time most Users will allow, generally in less than five minutes—so the User doesn't drop out and make a poor choice based on simplistic criteria such as lowest deductible or lowest premium (which are inadequate data points for choosing a health insurance plan), but allowing Users to drill down for extensive detail if they are able and so inclined.

In hopes of avoiding the shortcomings in various settings and applications of the prior art, including such art as it might be applied within Health Insurance Exchanges under the federal law called the Affordable Care Act, the present invention incorporates new and innovative best-practice features that should be built into any plan comparison tool.

The present invention does not rely on a known-usage calculator model of predicting insurance costs, although it can take into account known usage of relatively high-cost products or procedures where such known usage is known to be persistent—for example, for a high-cost maintenance drug and for selected conditions and procedures, it can estimate the likely out-of-pocket costs for those specific drugs, procedures, or conditions under each plan, including using research data on likely treatment frequencies and any plan-specific cost-sharing provisions, without requiring consumers to make guesses as to how many visits, tests, prescriptions, etc. might be incurred and without arbitrarily assuming that all visits, tests, prescriptions, etc. are paid the same.

The present invention overcomes all of the difficulties described in the prior art research and provides Users manageable and understandable choices with information on their most important concerns, including overall cost, physician participation, and plan care and service quality.

An online embodiment of the present invention is designed to help family members, counselors, Navigators, brokers, and other intermediaries give personalized advice and prepare personalized written materials. The term “Navigator” is a term used in the Affordable Care Act for a specific category of givers of assistance to enrollees. Navigators' main function is to provide advice and assistance to often unsophisticated enrollees, and Navigators will be greatly assisted in this function by the present invention.

An embodiment of the present invention is customized for employers in order that they can make plan purchasing decisions that reflect their own preferences with regard to such matters as holding their share of premium costs down and holding enrollee costs down. The present invention allows employers to compare, side-by-side, their cost per employee, and also their costs for all employees by comparing different contribution levels and methods. For example, in the simplest case where an employer provides the same flat premium subsidy level for all single employees (e.g., $5,000 a year), then the average cost would be $5,000. For an organization with 100 single employees, the total employer costs would be $500,000 for those employees, regardless of which plan each employee chooses. In such a case, employees can take into account the employer subsidy to see their share of premium plus estimated out-of-pocket costs under each plan. Additional estimating parameters, such as tax subsidies, are available to the smallest employers.

Taken together, these features of the present invention create the first tool that allows consumers to tailor their health insurance choices to their individual circumstances and preferences with valid information on the factors that matter most to consumers. The present invention, unlike any prior art tools, lets Users simultaneously choose the lowest overall cost health plan, the lowest cost health plan for many high cost conditions (such as planned pregnancy, hip replacement, and spinal fusion), a plan with the doctors they prefer, a plan with high-quality, low-cost doctors, and a plan that performs well on quality measures that matter most to the User.

The present invention, in a preferred embodiment, also is flexible so as to be able to include a new and innovative but low-cost prescription drug module that allows Users to enter the names of several thousand high cost drugs in much the same way they enter provider names, to see if those drugs are “preferred” in each plan; a “medical tourism” feature that allows Users to see the savings they can make if they use the first tier (often a geographically distant tier) of bargain, discount providers for care. The present invention is flexible to allow still other modifications to be added based on individual decisions by states, employers, and others who wish to use the tool. Thus, the present invention can be customized to a particular health insurance market and any particular health insurance plan design.

Consequently, the present invention, which encompasses the necessary and desirable features discussed above, represents a radical improvement over even the best prior art plan comparison tool.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a schematic block diagram and flow chart that depicts the broad structure and major components of the present invention, including the functionality of a key input and a key output module;

FIG. 2 is a schematic flow chart that depicts the method of the present invention from the perspective of a User, from the User's entering information on user characteristics and preferences into the system, or having information entered from other sources onward to the opportunity of a User to see displays of health plan cost, provider availability, and quality measures and interact with those displays onward to the plan selection and enrollment decision of the User;

FIG. 3 is a schematic block diagram that depicts the characteristics and preferences of the User Block of FIG. 2;

FIG. 4 is a schematic block flow diagram that depicts the calculation of the cost of a plan for a User using the Premium and Out-of-Pocket cost calculators;

FIG. 5 is a schematic block flow diagram that depicts the selection, calculation, and weighting of the Plan Quality Scores and Measures, including an optional personalization loop that adjusts the weighting and calculations to reflect user preferences;

FIG. 6 is a schematic block flow diagram that depicts the compilation and evaluation of the provider information including provider availability, quality and cost, and the generation of the Display Module;

FIG. 7 is a schematic block flow diagram that depicts the generation of the health plan presentation and display, summary display, and more detailed displays;

FIG. 8 is an actuarial table of the calculation of the estimated average yearly Out-of-Pocket Costs for individuals and families with characteristics like an exemplary User with coverage from an exemplary health plan;

FIG. 9 is a schematic block flow diagram that shows how the User's premium, after any subsidy, is received from another Exchange eligibility module, employer or other source or is calculated using information and rules received from plans or other sources, and shows the calculation of the cost to the User;

FIG. 10 is a schematic block flow diagram showing how the estimated out-of-pocket cost for people like the User is calculated based on population usage and expense data, the characteristics of the User (which are matched with profiles of similar individuals and families in the population), and plan benefit and coverage rules;

FIG. 11 is a schematic block flow diagram that shows how plan quality measures used in FIG. 5 are selected by expert opinion and how these measures are given weights by experts or by the User for the calculation of summary/composite measures of plan quality;

FIG. 12 is a screenshot of the summary display chart the User sees as mapped in FIG. 7, including showing for each plan the average combined total cost for individuals or families like the User, the most the User could pay in a year, an overall quality score, and a doctor result (i.e. whether the User's preferred doctors are in the plan), with the chart currently being arranged by the amount of “Combined Total Costs”;

FIG. 13 is a schematic block diagram of one embodiment of a computer system that can be used to run and display the present invention; and

FIG. 14 is a screenshot of the slider display chart the User sees as mapped in FIG. 7, when the “personalize here” link for the Overall Quality Score column of the summary display chart has been selected. The slider display chart shows a plurality of positioned slider bars and user considerations.

### DETAILED DESCRIPTION OF PREFERRED EMBODIMENTS

A specific embodiment of a health insurance plan comparison tool is now described with reference to the drawings in which the same elements or components are identified with the same numerals throughout the several views. The presently preferred embodiment of the present invention will be described with respect to a health insurance plan comparison tool.

As used in this specification, the following words have the following definitions and meanings;

A “health insurance event” is a particular health issue, and includes pregnancy and child birth, a heart attack, and a kidney stone.

A “filter” is a tool that allows the User to change the breadth or scope of the display and of the calculations. Examples of Filters are selection of plan type such as one or more of HMO, PPO, and CDHP/HDHP and the selection of an acceptable quality score range for health insurance plans to be displayed.

A “measure” is a rating or evaluation of a feature such as the quality of a doctor, the availability of a doctor, the customer service and claims handling of a health insurance plan, and whether members of a health insurance plan get recommended medical tests and treatments as part of the plan, etc.

A “Module” includes at least a computer program routine that has a limited, specialized function. However, the functions stated as being performed by a certain module can be performed by another module or in combination with other functions, and the particular identification of a module is one of convenience and for clarity.

An “Offeror” is defined in general to include a person or entity that provides a service or product, including health insurance, or enables another person or entity to provide a service or product, including health insurance. Examples of an offeror include a larger entity such as an insurance company or a government, or a smaller entity such as a doctor.

A “Provider” is defined as a person or entity that directly performs a service to the User, such as a physician or a therapist participating in a health insurance plan.

A “User” is defined as an individual or family unit or an employer or other entity considering and/or selecting the purchase of a health insurance offering, and includes someone assisting the User.

Initially it is noted that in order properly to compare the large number of available insurance plans, consumer information is needed. Health care expenses vary, for example, not only by number of family members but also by age of family members and other characteristics. The average health insurance costs incurred for Medicare enrollees is approximately $15,000 a year, in contrast to less than $2,000 a year for a person under the age of 25. Therefore data on consumer Users is needed, for example, on the number of family members and the ages of each, on the geographic location of each family member who will be a member of the plan, and on other characteristics, which can include the overall health status and health care conditions of each member. In addition, the consumer User needs to input preferences for their health care providers for each specialty that they need (for example, gynecologists, internists, and orthopedists). Input data is also needed as to the personal preferences of each consumer User of which aspects of a health insurance plan quality are the most important to them (e.g., how a particular plan scores on quality measures related to treatment of specific diseases or how the plan scores on its frequency of disputed claims).

### A. OVERVIEW OF A TOOL ACCORDING TO THE PRESENT INVENTION

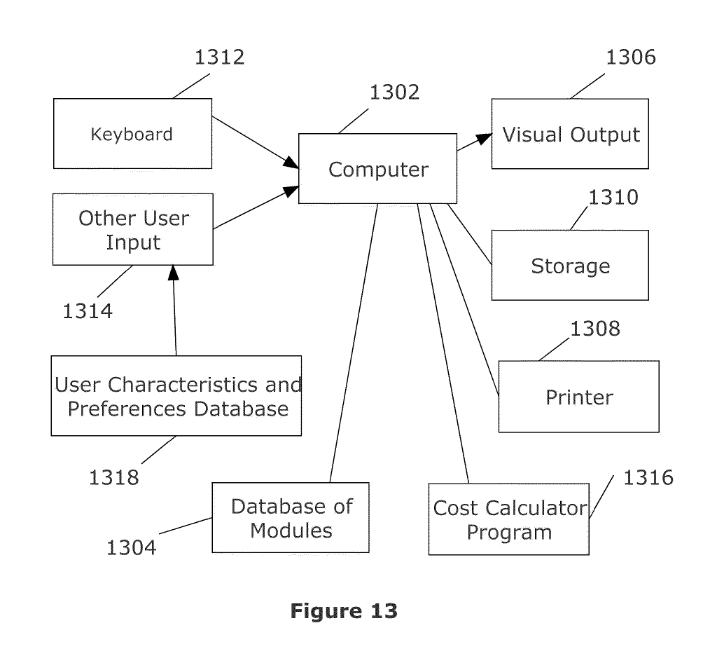

With reference now to FIG. 13, a conventional computer system in a general outline form is depicted. A conventional general purpose, digital computer 1302 receives a computer program and data inputs from a general database 1304 and provides data outputs to a visual output 1306, such as a conventional video monitor, to a conventional printer 1308, and to a storage medium 1310. Computer 1302 is a general representation of a means for running the computer program that does the calculations and generates the visual presentation according to the present invention as described herein below.

Computer 1302 can be a conventional laptop or desktop personal computer, a minicomputer, a tablet, a smartphone, a mainframe computer, or even a high speed computer, although in several variations, components—including user input, computer, visual output, and storage—may all be in a single physical device. Computer 1302 uses a conventional operating system that can be stored in a computer readable storage device, in the computer itself or stored off site and delivered to the computer (e.g. cloud computing). Computer 1302 also uses called programs, such as cost calculator program 1316, which can be stored in a program database. Alternatively, computer 1302 could be symbolic of cloud computing in which the computer engine and/or storage 1310 is provided by a source located somewhere in the internet cloud at one or more locations and accessed through the Internet.

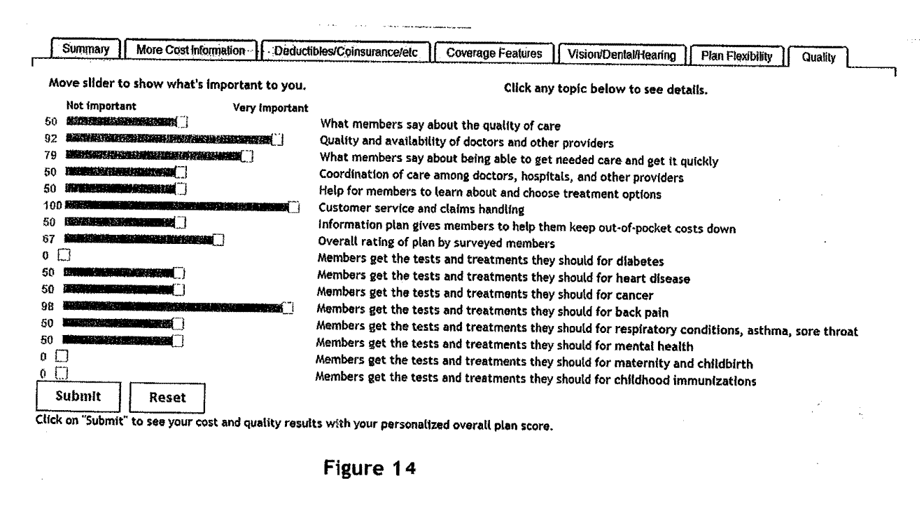

Inputs to computer 1302 come from a user input source such as a manual input from a conventional keyboard 1312 or from another input source 1314, such as a voice recognition system, a scanned input card or record, stored input, a User input selected by moving a slider on a video monitor touch screen (see, e.g. FIG. 14), or another source that receives and stores information from or about the User. User input source 1314 provides User characteristics and preferences from a data base 1318. User inputs are used by the present invention to make the calculations and video presentations. Inputs can also come from database 1304 and can come from sources in the internet cloud, such as specialty websites.

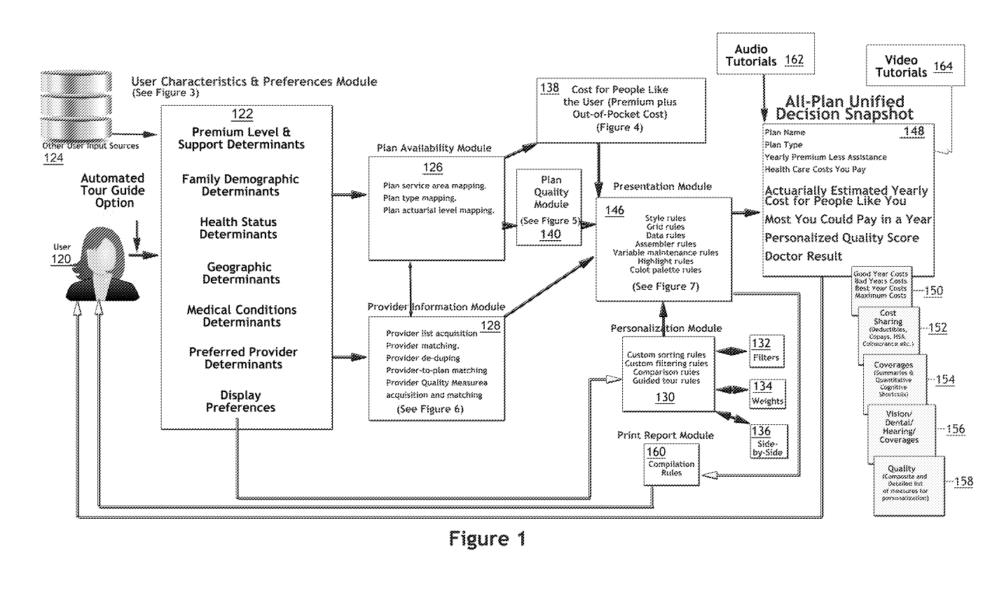

With reference now to FIG. 1, a general description of a system in accordance with the present invention is described. In the figures, a comparison and selector tool is described with respect to a plurality of health insurance plans and utilizes a computer program. Such a computer program is disclosed in FIG. 1 as having a plurality of exemplary modules or subroutines and their interconnections. Each plan, generally referred to as an offering, is offered by a health insurance offeror, such as an insurance company or by a government agency. A User who desires to evaluate the various health insurance plans that are available to the User and to choose a particular one is symbolized at 120. User 120 first accesses a User Characteristics and Preferences Module 122, which collects the specific characteristics and preferences from User 120. In general, these items include personal information such as family demographic determinants, health status determinants, geographic determinants, and medical conditions determinants; and include user preferences such as preferred provider determinants and output and display determinants. The user characteristic information is used by the present invention to determine which health plans and features of health plans are available to the User, what the premium and out-of-pocket costs are for the User, and which plan and provider quality measures and weights are most appropriate for the User. The types of information that will be provided on user characteristics may include, for example, what family members might be covered by the insurances, their ages, their genders, their zip codes, tobacco use status, when coverage is to begin, self-reported health status, income, and/or whether they have certain health conditions or other care usage considerations (for example, planned childbirth, planned hip replacement, and required expensive maintenance drug program).

Module 122 can also obtain automatically, based on user inputs, or manually as based on user selections, other input information from input sources generally labeled 124, and described in greater detail herein below.

Module 122 provides information and instructions to both a Plan Availability Module 126 and a Provider Information Module 128. Module 126 provides plan availability using the following methods: service area mapping, plan type mapping, plan actuarial level mapping, and possibly other mapping such as mapping of plans chosen by an employer. Module 128 provides health care provider availability based on acquired data, provider matching, provider de-duping and provider-to-plan matching. Module 128 also provides provider quality measures, and performs acquisition and matching of providers with health insurance plans (i.e. the plans that the providers participate in). Each of these features is described in greater detail herein below. In addition, Module 122 is connected to a Personalization Module 130 in which custom sorting rules, custom filtering and weighting rules, comparison rules, and guided tour rules are used to select and apply user-specific preferences. Module 130 uses called filters from a Filters Database 132, weights from a Weights Database 134 and display preferences from a Side-By-Side Database 136, to calculate and display user-specific results in a Presentation Module 146.

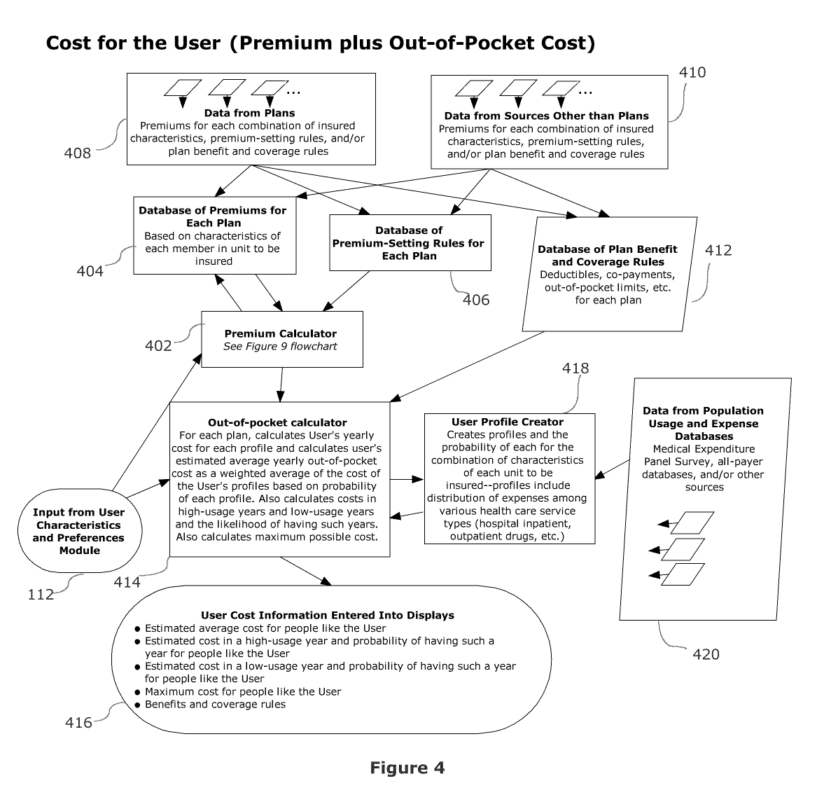

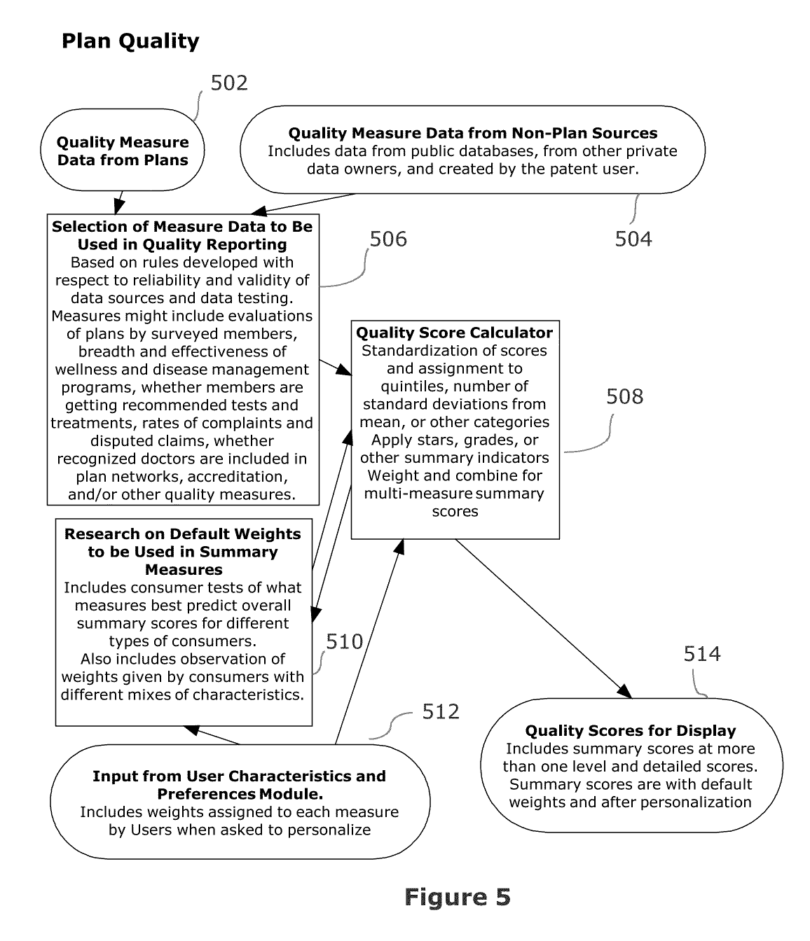

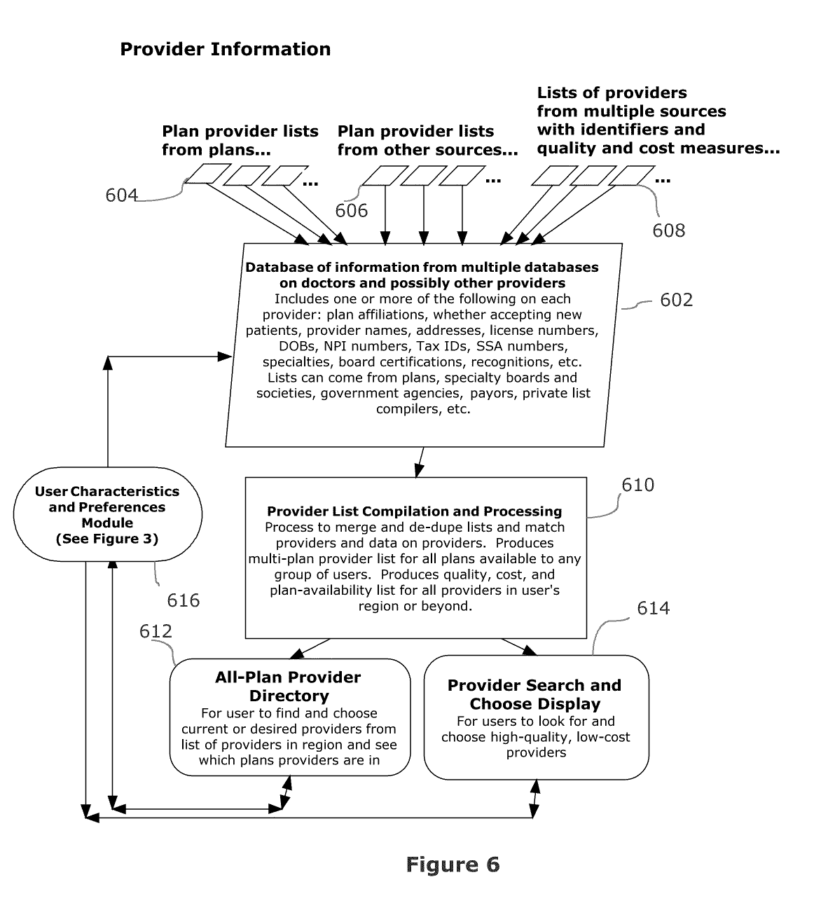

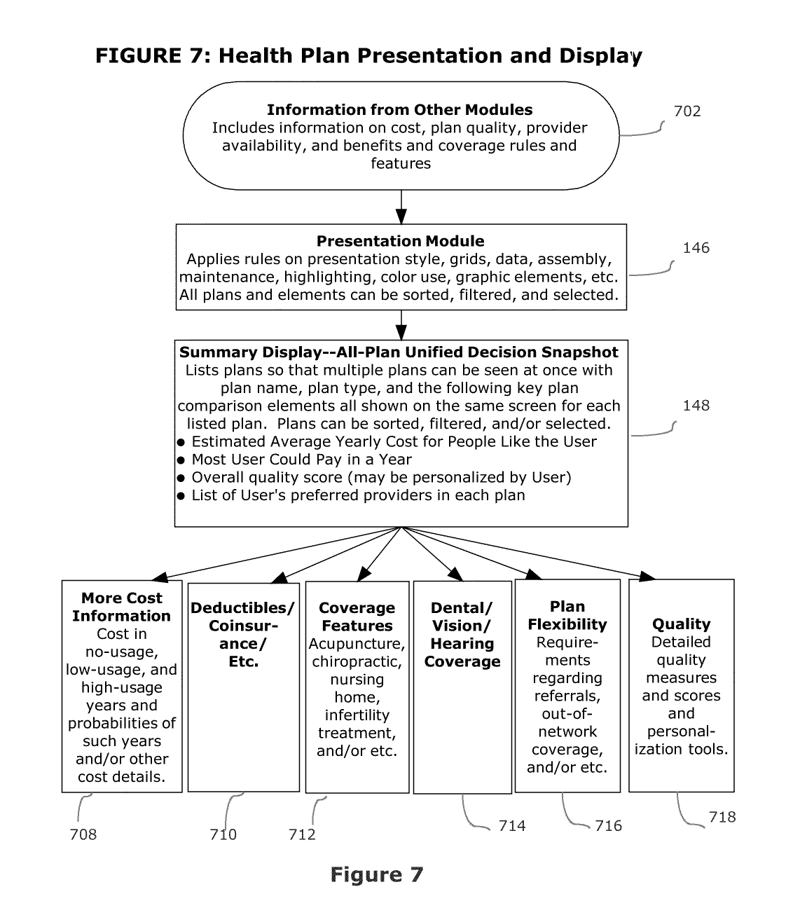

Plan Availability Module 126 also provides an output to an Actuarial Cost Calculator Module 138 and a Plan Quality Module 140. Module 138 is discussed below with respect to FIG. 4 and Module 140 is discussed below with respect to FIG. 5. Provider Information Module 128 also sends and receives information to and from Presentation Module 146, and is discussed below with respect to FIG. 6. Presentation Module 146 is also discussed below with respect to FIG. 7. Presentation Module 146 provides style rules, grid rules, data rules, assembler rules, variable maintenance rules, highlight rules, and the color palette rules.

Presentation Module 146 is the module that selects, arranges and provides information to be presented to User 120 via a Print Report Module 160. Presentation Module 146 also provides information to User 120 via an All-Plan Unified Decision Snapshot Module 148. Snapshot Module 148 assembles and builds plan display information and selection information from a number of databases 150 through 158. This information includes the plan name, the plan type, the yearly premium less assistance, and a calculated health insurance cost that User 120 will pay. Snapshot Module 148 also displays comparative information such as actuarially estimated yearly cost for Users that are similar to User 120, the most a User could pay in a year, the personalized quality score of the plans, and the corresponding list of doctors that participate with the displayed plans among doctors that the User asks about. Module 148 uses actuarial information contained in a Costs Database 150 that provides good year costs, bad year costs, best year costs and maximum costs. Module 148 also uses information contained in a cost sharing database 152, a coverages database 154, a special coverage database 156 and a quality database 158. Cost sharing database 152 provides cost sharing based on deductibles, copays, HSA, coinsurance, etc. Database 154 contains calculations and information about summaries and quantitative cognitive shortcuts. Database 156 contains information about specialty coverages in an insurance plan such as vision, dental and hearing coverages. Database 158 contains information about quality—In particular, composite and detailed lists of measures for personalization by User 120 of a plan. Databases 150 through 158 all provide information that can be displayed on request to the User 120.

The User 120 can gain initial education and training about the use and application of the Health Insurance comparison tool through electronically stored Audio and Video tutorials stored in a data base 162 and a data base 164, respectively, which tutorials can be created before the
User 120 begins to use the plan comparison tool of the present invention.

### B. OVERVIEW OF THE PRESENT INVENTION FROM THE USER EXPERIENCE PERSPECTIVE

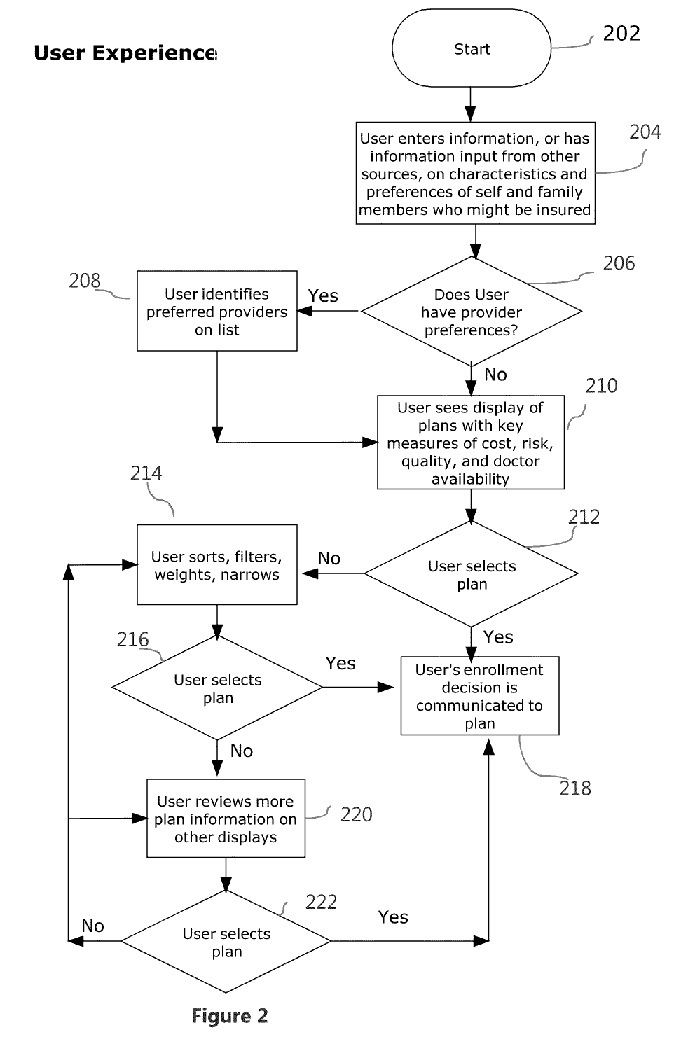

As depicted in FIG. 2, the present invention enables the User to enter or import information about characteristics of the User (including family members, employers, or employees); enables the User to indicate if the User has any providers the User would like to have available in a health plan and to see information on providers; enables the User to see a summary display of key measures of actuarially-estimated plan cost, risk, quality, and doctor availability for all available plans; enables the User to make a plan selection based on this summary information; enables the User to opt to see more information about the available plans; and enables the User to sort, weight, filter, or narrow what is displayed based on personal preferences and then make a plan selection.

With specific reference now to FIG. 2, a flow chart of the user experience in using one embodiment of the present invention is now described. In a step 202, the User starts or accesses the User Characteristics and Preferences Subroutine and is immediately requested in a step 204 to enter personal information as requested by the program or to input requested information from another source, such as from a previously created database base to which the User has access. As is well known in the computer art, step 202 could also include a sign-on routine that provides access to a User only after an appropriate password is entered. The requested personal information is generally on the characteristics and preferences of the User and the family members of the User who are to be insured. This information can include the answers to the following exemplary questions which are asked by the program:
1. Input that may be collected from Users or persons assisting Users:
   What family members might be covered by the insurances?
   What are their ages?
   What are their genders?
   What is their zip code?
   When do they want coverage to begin?
   Do they use tobacco (yes means the individual has smoked tobacco in such forms as a cigarette, pipe or cigar, or used smokeless tobacco, such as snuff or chewing tobacco, within the past six months)?
   How would they describe their health status (on a poor, fair, good, very good, or excellent scale)?
   What is their income?
   Are they entitled to premium subsidy or cost reduction?
   Do they have certain health conditions or other usage considerations (for example, planned childbirth, planned hip replacement, and/or expensive maintenance drug, etc.)?
   What relative weight do they give to various health plan quality measures (for example, measures of quality and availability of doctors, customer service and claims handling, and/or whether members get recommended tests and treatments for various conditions, etc.)?
2. Input on Users from other sources that can come in database or other form from plans, from health insurance exchange plan management functions, and/or from independent compilers of health plan provider directories (possibly health insurance exchange eligibility engines or employers):
   What family members might be covered by the insurances?
   What are their ages?
   What are their genders?
   What is their zip code?
   When do they want coverage to begin?
   Do they use tobacco (yes means the individual has smoked tobacco in such forms as a cigarette, pipe or cigar, or used smokeless tobacco, such as snuff or chewing tobacco, within the past six months)?
   How would they describe their health status (on a poor, fair, good, very good, or excellent scale)?
   What is their income?
   Are they entitled to premium subsidy or cost reduction?
   Do they have certain health conditions or other usage considerations (for example, planned childbirth, planned hip replacement, and/or expensive maintenance drug, etc.)?
   What relative weight do they give to various health plan quality measures (for example, measures of quality and availability of doctors, customer service and claims handling, and/or whether members get recommended tests and treatments for various conditions, etc.)?

In a step 206 which is depicted at a decision diamond, the User is asked if she or he has any provider preferences. If the User says “yes”, the program branches to a step 208 in which the User is asked a number of questions about providers, including the names of doctors or other providers who are available in the plans being compared.

After the User identifies the preferred providers, or if in the decision diamond 206 the User indicates that there are no provider preferences, the program continues to step 210. In step 210 the User sees a display of different plans automatically selected based on the input information in step 204 and step 208. For example, some plans are not available in the zip code of the User and thus they would be filtered out. The display of plans includes key measures of cost, risk, quality, and doctor availability.
The User is then given the opportunity in a step 212 represented by a decision diamond to select a plan. If the User cannot select a plan at this point, the program continues to a step 214 where the User sorts, filters, adds weights and narrows the plans. The resultant plans that fit these criteria are presented to the User and the User is again asked to select a plan in a step 216 represented by a decision diamond. If the User does select a plan at step 214, or at step 212 above, the program proceeds to step 218 where the User's enrollment decision is communicated to the selected plan or to another entity that can enroll the User.
However, if the User still cannot select a plan at step 216, the program branches to a step 220 in which more plan information on other displays is presented. The User is then asked again to select a plan in a step 222 represented by a decision diamond. If a selection is now made, then the program branches to step 218 where the selection is communicated to the plan or to another entity that can enroll the User. However, if the User still cannot make a decision, then the program branches back to step 214 where the User sorts, filters, weights and further narrows the now reduced presentation of plans. The process continues in this cycle until a plan is selected in step 222.

Exemplary sorts and filters performed in step 214 include exemplary questions asked of the User such as:
Does the User want to sort or filter plans on various characteristics (for example, type of plan, estimated average likely total yearly cost for people like them, maximum total cost, total cost in a high-usage year, overall or specific quality measures (including personalized overall measures), premium, and/or etc.)?
Does the User want to see details on deductible/coinsurances/etc., special plan features, dental/vision/hearing coverage, quality measures, and/or etc.?
Does the User want to select specific plans on which to see greater detail or to enroll?
Does the User want audio, video, or text explanations or advice?

Exemplary sorts and filters performed in step 220 include exemplary questions asked of the User as in step 214, but in greater detail.
3. Input on health insurance plans related to cost calculations and coverage from the health plans themselves or from intermediaries with information on health plans (for example, health insurance exchange plan management functions or brokers) or from Users or persons assisting Users who have collected information on health plans such as the following:
   Premiums of specific plans for specific insureds and/or for various categories of potential insureds (for example, by age, gender, zip code, tobacco use, when coverage is to begin, and/or etc.) and/or rules and formulas for calculating such premiums.
   Premium subsidies available to specific insureds and/or to various categories of potential insureds.
   Summary of benefits and coverages of specific plans (in database, hard copy, or other form).
4. Information on health insurance plans related to plan quality can come from a variety of sources, including the health plans themselves, plan measurement entities like the National Committee for Quality Assurance or the National Business Coalition on Health, health insurance exchange plan management functions, compilers of health plan quality measures, and/or direct data collection of information through surveys or other means by the patent implementer). The information includes:
   Measures of quality and availability of doctors;
   Measures of customer service and claims handling;
   Measures of whether members get recommended tests and treatments for various conditions; and/or
   Measures of plan-provided wellness, disease management, and/or care coordination programs.
5. Information on availability of physicians and possibly other providers in plans and on the quality and/or cost of providers. This module receives health plan provider lists from the health plans and/or from other sources, and it also receives information on the quality and cost of providers from plans and/or other sources. Types of information received can include:
   Names, addresses, phone numbers,
   National Provider Identifier numbers,
   Tax ID numbers,
   DEA numbers, License numbers,
   Medical school year of graduation,
   Date of birth,
   Specialty, and/or
   Other identifiers that facilitate matching providers across plans and matching providers to databases of provider quality and cost measures.
      Information received also includes various types of information related to provider quality and cost, including information on:
   Board certification,
   Other training,
   Hospital affiliations,
   Use of electronic medical records,
   Group practice participation/arrangements,
   Patient experience survey results,
   Measures of whether patients get recommended tests and treatments,
   Measures of care coordination,
   Indicators of overuse of procedures,
   Clinical outcomes,
   Patient-reported outcomes,
   Pricing information, and/or
   Other indicators (such as peer review, disciplinary actions, and other professional recognition).

### C. USER CHARACTERISTICS AND PREFERENCES MODULE

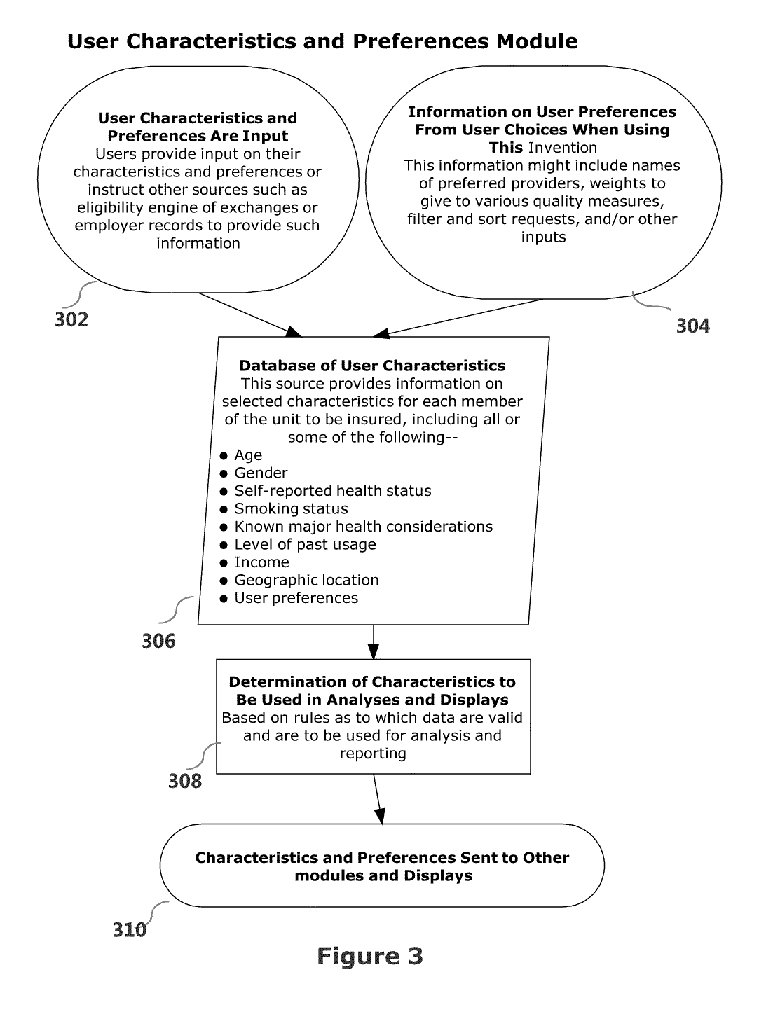

In FIG. 3, the User Characteristics and Preference Module 122 of the present invention is depicted. Module 122 involves the data entry portion of the system. As stated above, in this Module information on the User's individual or family characteristics is entered and user preferences are entered. As set forth in more general terms, these user characteristics can be entered directly by the User (including anyone assisting the User) into an online form or questionnaire or can be communicated to the invention from other sources of such information. Such other sources include, for example, health insurance exchange eligibility engines or employers of the Users.

The user preference information is provided along with the user characteristic information. In an alternative embodiment, this information can be provided as the User interacts with lists and displays the User sees while using the website. This user preference information might include the names of doctors or other providers for which the User would like to know about availability in the plans being compared; what relative weights the User gives to various health plan quality measures (for example, measures of quality and availability of doctors, customer service and claims handling, whether members get recommended tests and treatments for various conditions, and/or etc.); how—if at all—the User wants to sort or filter plans on various characteristics (for example, type of plan, estimated average likely total yearly cost for people like them, maximum total cost, total cost in a high-usage year, overall or specific quality measures (including personalized overall measures), premium, and/or etc.; whether the User wants to see details on deductible/coinsurances/etc., special plan features, dental/vision/hearing coverage, quality measures, and/or etc.; whether the User wants to select specific plans on which to see greater detail or to enroll; and/or whether the User wants audio, video, and/or text explanations or advice.

The User Characteristics and Preferences Module 122 of FIG. 1 has a database structure and rules for formatting and storing the entered information and has rules for selecting the information that will be sent to, or provided in response to queries from, other components of the present invention. As shown in FIG. 3, User Characteristics and Preferences Module 122 collects input from step 302 and step 304 and stores it in a database of User Characteristics 306. In step 302, Users provide input on their characteristics and preferences or by a command such information is provided by other sources such as eligibility engines of exchanges or employer records. In step 304, Users provide the choices on their preferences, which includes names of preferred providers, weights to given to various quality measures, various filters to be applied, and any sort requests they might have.

The information and controls provided in steps 302 and 304 are stored in a database 306. Database 306 provides information on selected characteristics for each member of the unit to be insured, including some or all of the following:
Age;
Gender;
Self-reported health status;
Smoking status;
Known major health considerations;
Income;
Geographic location; and
User preferences.

Information from database 306 is provided as called in a step 308 where a determination of characteristics to be used in analyses and displays is made. These decisions are based on rules as to which data are valid and are to be used for analysis and reporting. From step 308 the results are outputted from module 122 in output step 310.

### D. COST FOR THE USER

The cost of an insurance plan for the User is determined in Actuarial Cost Calculator Module 138, which is depicted in FIG. 4. Module 138 receives information and calculates user expenses for premiums and out-of-pocket expenses for health care usage that is not paid for by insurance.

One feature of Cost Module 138 is a Premium Calculator 402, which receives data from a database 404. Database 404 contains premiums for each combination of insured characteristics such as age and household size premium-setting rules, and/or plan benefit and coverage rules per plan from database 406. Specialized databases 408 and 410 provide data to databases 404 and 406, as well to an additional database 412 that contains plan benefits and coverage rules. Specialized database 408 contains data from each plan, which includes premiums for each. The premium setting rules for database 406 and the premium tables for database 404 are derived from the plans themselves stored in database 408, or from other sources accessed for database 410, such as State health insurance exchanges, employers, or directly from the User based on review of plan brochures or sales materials. Specialized database 408 contains data from each plan, which includes premiums for each combination of insured characteristics, premium-setting rules, and/or plan benefit and coverage rules. Specialized database 410 contains data from other sources than from insurance plans. The other sources include plan management functions of State health insurance exchanges or employers or directly from the User based on review on plan brochures or sales materials. The data received in this way includes actual premiums that insureds are required to pay based on a combination of insured characteristics, premium-setting rules, and/or plan benefits and coverage rules. For the information that is rules-based rather than premiums, Premium Calculator 402 calculates the premiums for a large number of combinations of characteristics of potential insureds.

If premiums are to be adjusted or subsidized according to income or some other characteristics of insureds, the Premium Calculator 402 calculates premiums for insureds as adjusted according to such income or other characteristics and known subsidy amounts and such adjusted or subsidized premium amounts will also be categorized and stored.

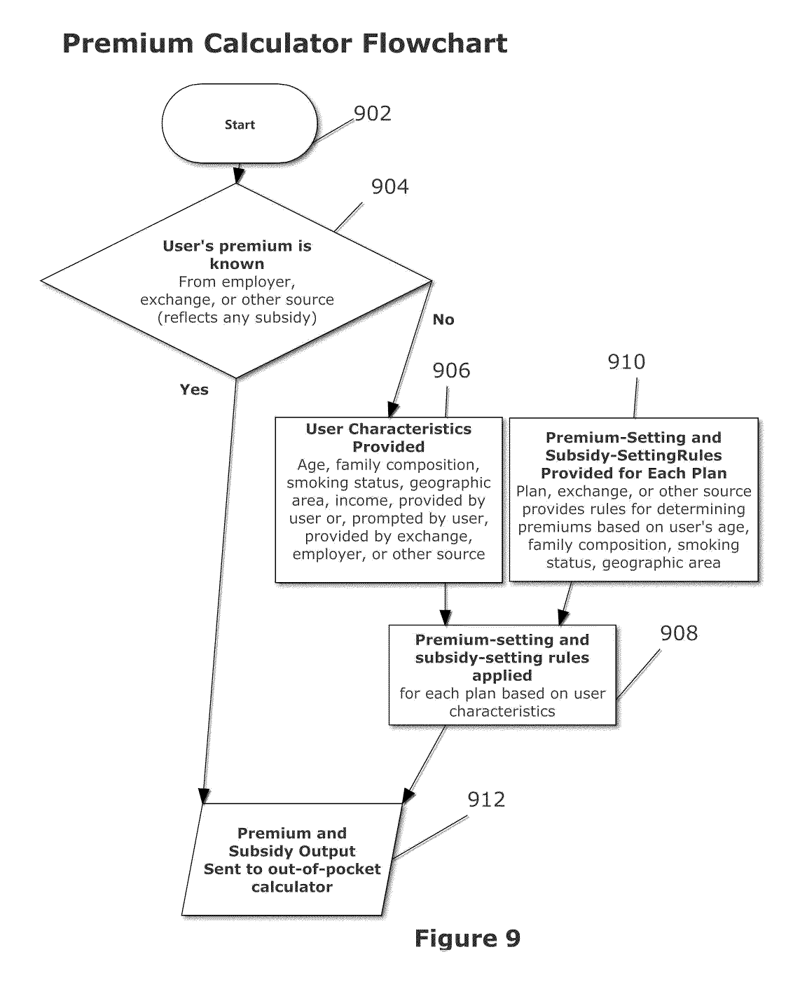

A presently preferred embodiment of a Premium Calculator 402 is depicted in FIG. 9. The subroutine that performs the functions of the aforedescribed Premium Calculator begins when called in a start input oval 902. The program proceeds to a step 904 represented by a decision diamond where it is determined if the User's premium is known. The premium can be obtained and stored in the system from the employer, an exchange, or other sources.

If the premium is not known, the program branches to a step 906 in which the characteristics of the User are obtained either from a database or an input from the User. The program then proceeds to step 908 where the premium-setting and subsidy-setting rules are applied using the user characteristics and rules obtained from a step 910. The user characteristics selected in step 906 are those required by the rules for a particular insurance plan. These characteristics include age, family composition, smoking status, geographic area, and income. The characteristics can be obtained real time from the User, for example, by an entry from keyboard input 1312 or from database 1314 via other user inputs devices 1314. The particular rule obtained in step 910 is provided for each plan from the plan itself, from an exchange, or from other source. The rules, sometimes in the form of an equation or algorithm, are provided by the insurance plan and the calculations are straight forward using the inputs from steps 906 and 910. Alternatively, the algorithm can be embedded in a lookup database or table where the inputs that are used are the user characteristics.

Finally, the premium and subsidy output or the known premium from step 904 is assembled in step 912 and provided as an output to an Out-Of-Pocket Calculator 414, which is the central element of the User Cost Module, and from there to an output 416 and to the display modules for each User based on the user characteristics.

Out-of-Pocket Calculator 414 receives information for its calculations from Premium Calculator 402, User Profile Creator 418, and Input from the User based on user preferences 122. Thus, it receives data from plans or from other sources (such as plan management functions of State health insurance exchanges, or employers or directly from the User which is based on information in plan brochures or sales materials) on the benefit and coverage terms of each plan (deductibles, co-payment amounts, coinsurance levels, out-of-pocket limits, etc.) and the present invention formats, categorizes, and stores this information.

For each User, for each plan, Out-Of-Pocket Calculator 414 calculates using standard actuarial techniques the User's yearly (or other time period) cost for each of the applicable user profiles of people like the User based on calculations using the plan's benefit and coverage terms. Out-Of-Pocket Cost Calculator 414 then calculates a weighted average of the cost of the user profiles of people like the User based on the probability of each profile. This weighted average is the estimated average yearly out-of-pocket cost not covered by insurance for people like the User and based on the probability of each profile. Thus, Out-of-Pocket Calculator 414 calculates for each plan the average yearly cost for people like the User (i.e., similar age and household-size, etc.) as a weighted average using profiles and probabilities of each for people like the User. Out-of-Pocket Calculator 414 also calculates costs in high-usage years and low-usage years and the likelihood of having such years. Further it calculates maximum possible cost.

User Profile Creator 418 uses information from database 420 to create possible profiles and assign probabilities to each profile for the combination of characteristics of each User that might be insured for large numbers of possible user types as defined by combinations of characteristics of potential Users. The profiles include distribution of health insurance care usage and expenses based on databases of representative populations. Such databases include, or are similar to, the Medical Expenditure Panel Survey database and/or all-payer claims databases such as the Maine HEalthData Organizations' HealthCost database. Each such profile includes the amount and distribution of expenses among various health care service and product types (hospital inpatient, outpatient drugs, etc.) and the probability of anyone with the characteristics of a User falling into such a profile based on the characteristics of the User (family size, age, etc. of the members of the User). There can be, depending on the preferences of the implementer and the specific calculation procedure programmed into this invention, as many profiles as there are individual and family units in the database that is the source of the population usage and expenditure data.

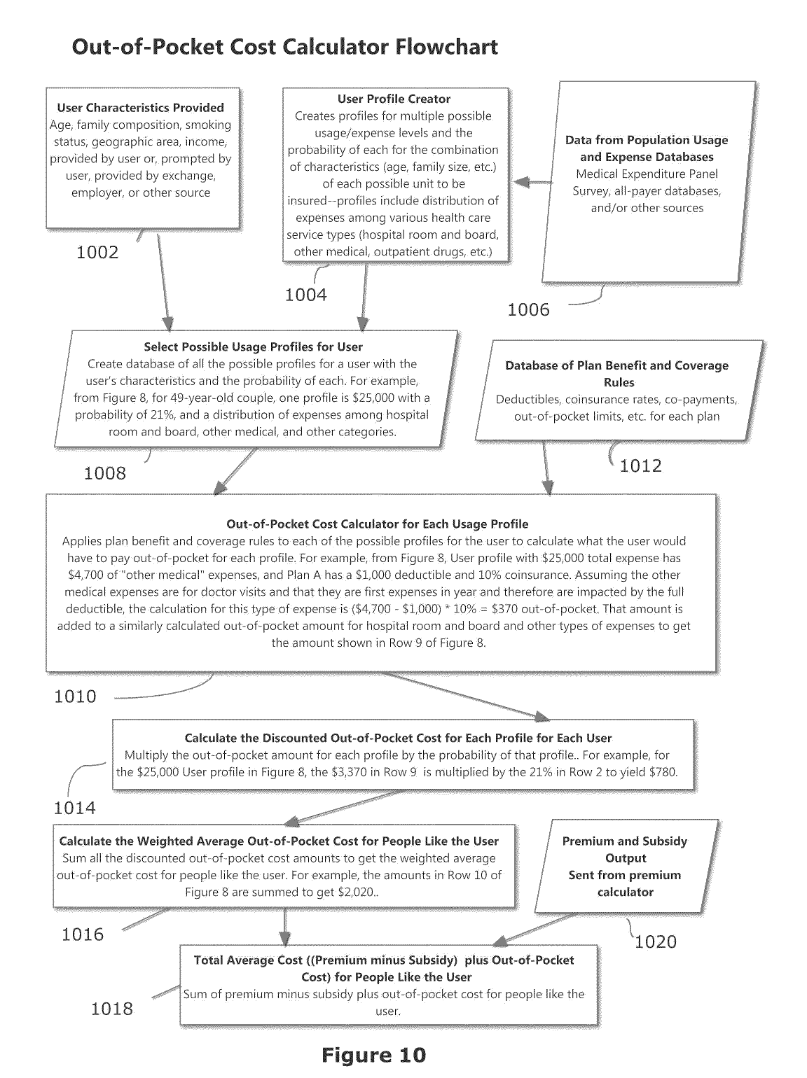

The actual operation of Out-Of-Pocket Calculator 414 is depicted in FIG. 10. The subroutine begins in step 1002 where, as in the Premium Calculator 406, the user characteristics are obtained. Many of these characteristics are the same as those provided in step 906 in the premium calculator, and these results can be used in step 1002, as the user characteristics may be needed. The user characteristics provided in step 1002 include age, family composition, and other characteristics provided by the User or provided by an exchange, employer, or other source upon the command of the User.

User characteristics provided in step 1002 together with a user profile creator step 1004, are provided to step 1008 where the possible usage profiles for the User are selected. In step 1004, user profiles are created for multiple possible usage/expense levels and the probability of each for the combination of characteristics (e.g. age and family size) of each possible user type to be insured. The profiles include distribution of expenses among various health care service types (e.g. hospital room and board, outpatient drugs). User Profile Creator step 1004 obtains data from step 1006, which includes data from population usage and expense databases, medical expenditure panel survey, all-payer databases, and/or other sources.

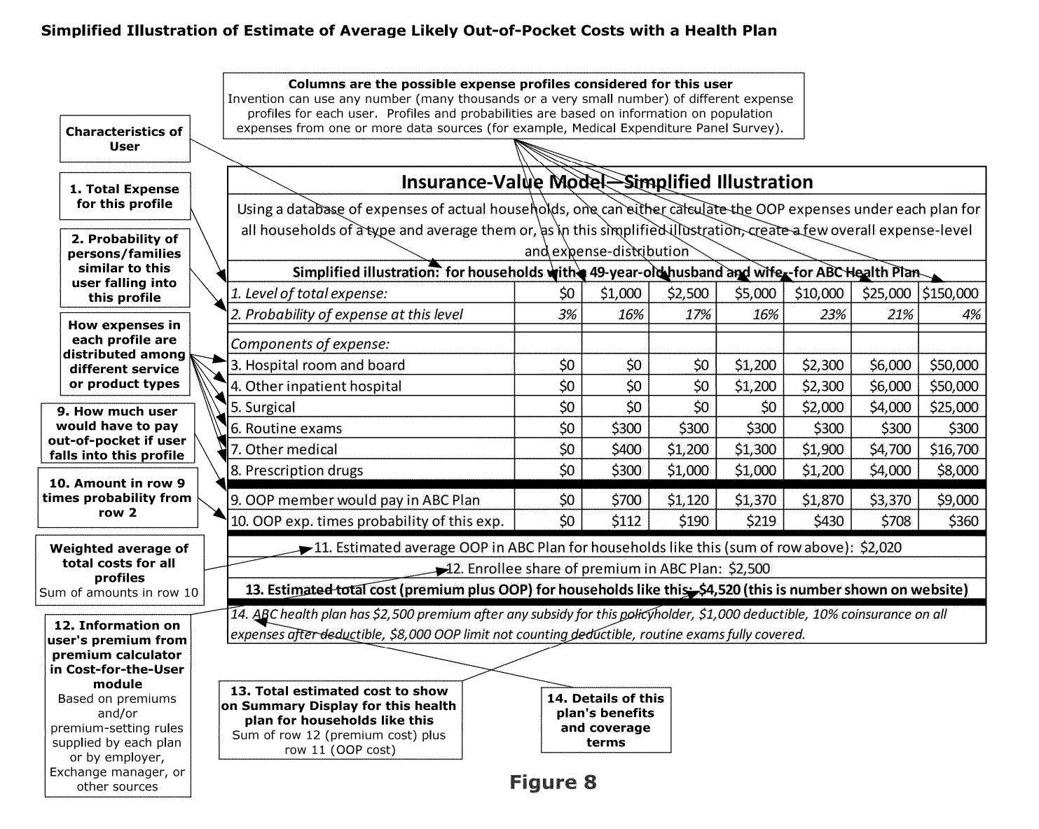

In a step 1008, a database of all the possible profiles and the probability of each is created for the User. For example, from FIG. 8 for a 49-year old couple, one profile is $25,000 with a probability of 21% and a distribution of expenses among hospital room and board and other medical costs and categories.

The outputs from step 1008 are provided to an out-of-pocket cost calculator in step 1010 together with the input from a plan benefits and coverage rules database 1012. Such rules include deductibles, coinsurance rates, co-payments, out-of-pocket limits etc. for each plan. In step 1010, the plan benefit and coverage rules are applied to each of the possible profiles for the User to calculate what the User would have to pay out-of-pocket for each profile. For example, from FIG. 8, user profile with $25,000 total expense has $4,700 of other medical expenses, and Plan A has a $1,000 deductible and a 10% coinsurance. Assuming the other medical expenses are for doctor visits and that they are first expenses in the year and therefore are impacted by the full deductible, the calculation of this type of expense would then be $370=0.10($4,700−$1000). That amount is added to a similarly calculated out-of-pocket amount for hospital room and board and other types of expenses to get the amount shown in Row 9 of FIG. 8.

Then in a step 1014, the discounted out-of-pocket Cost for People Like the User is calculated for each profile for each User. This is done my multiplying the out-of-pocket total for each profile by the probability of that profile occurring. For example, for the $25,000 user profile in FIG. 8, the $3,370 in Row 9 is multiplied by the 21% probability in Row 2 to yield $708.

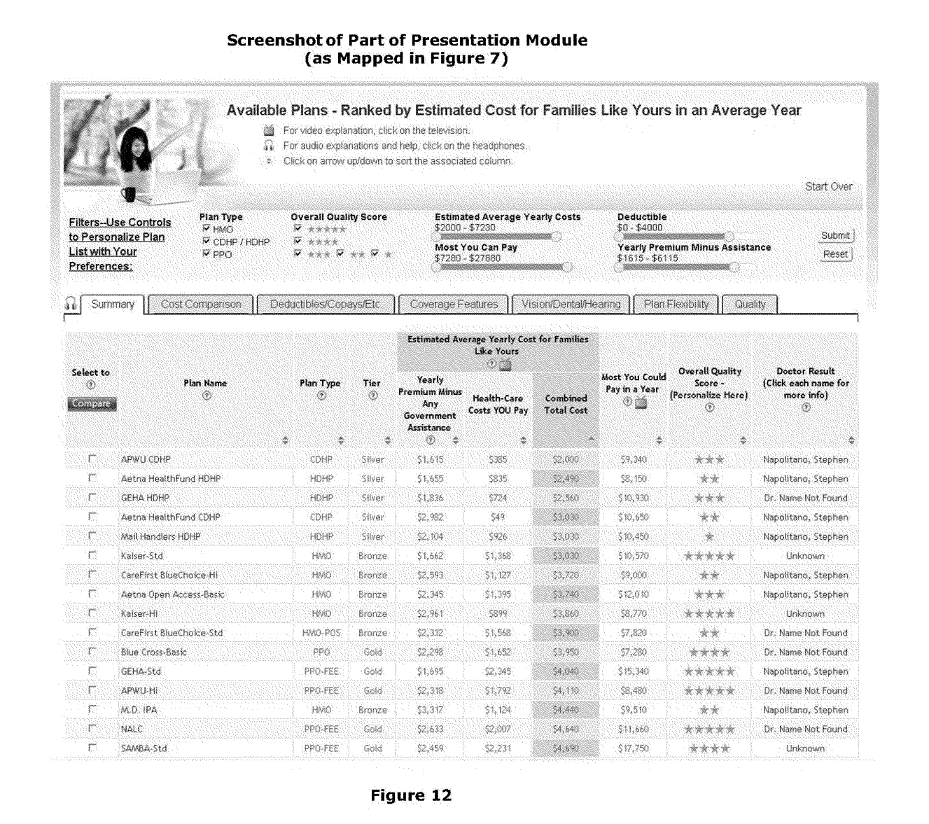

The program proceeds to the final step in the cost calculator calculation of a weighted average in a step 1018. In step 1018, the total average cost (premium minus subsidy) plus out-of-pocket costs is calculated for people like the User. Step 1018 makes the calculation using the generated premium amount and a subsidy output from the output of a step 1020, which is sent from the Premium calculator to obtain the Estimated Average Yearly Cost for People Like the User. That amount is a key figure reported in the All-Plan Decision Support Snapshot (see for example the 6^{th} column in FIG. 12) and other displays and is passed along to those displays.

### E. PLAN QUALITY SCORES AND MEASURES

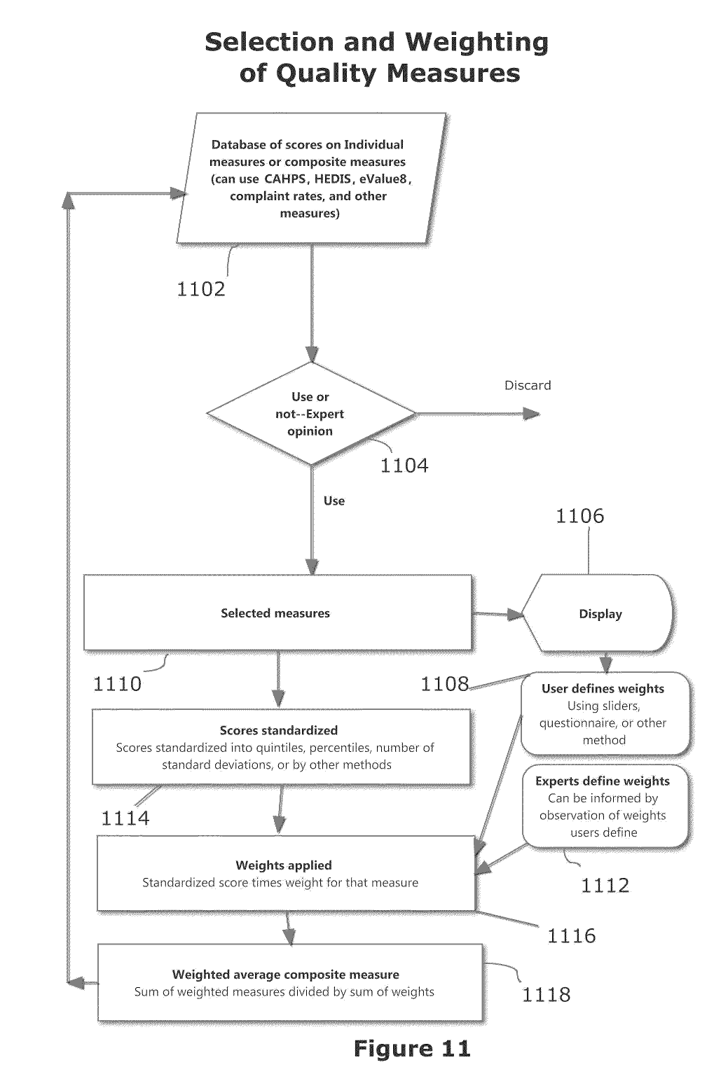

Plan Quality module 140 of FIG. 1 is depicted in greater details in FIG. 5 and FIG. 11, and produces personalized plan quality scores. Quality measure data from insurance plans is received from an input step 502 and from non plan sources is received from an input step 504, These other non-plan sources include plan measurement entities like the National Committee for Quality Assurance or the National Business Coalition on Health, health insurance exchange plan management functions, compilers of health plan quality measures, and/or direct data collection of information through surveys or other means by the patent implementer.

In a module step 506 the data from steps 502 and 504 are received and the measures to use are selected based on rules developed with respect to reliability and validity of data sources and on data testing, and such measures are formatted, categorized, and stored. For example such measures might include evaluations of plans by surveyed members (for example, the percent of surveyed members who said they can always get an appointment as soon as needed), breadth and effectiveness of wellness and disease management programs, whether members are getting recommended tests and treatments, rates of complaints and disputed claims, whether recognized doctors are included in plan networks, accreditation and/or other quality measures.

The selected measure data from step 506 is provided to a module calculator step 508 in which a quality score calculator standardizes scores and assigns scores to categories based on percentiles, quintiles, number of standard deviations from mean, or other categorization schemes. Also, stars, grades, or other consistent indicators are applied.

In calculator step 508, multi-measure summary scores are also calculated by weighting and combining the scores from individual measures. The output from calculator step 508 is provided to a display determination step 514.

Calculator 508 receives input from a research database 510 that contains research on default weights to be used in summary measures and input at input port 512. Input port 512 receives data from user characteristics and preferences module 122 that includes weights assigned to each measure by Users when they personalize their choices. Input port 512 also transfers the input to database 510. Research database 510 includes consumer tests of what measures best predict overall summary scores for different types of consumers. Also it includes observation of weights given by consumers with different mixes of characteristics, and it develops rules as to default weights to be assigned to different measures based on their importance to different types of Users. Research database also analyzes what weights best predict summary scores for different types of Users and observes what weights are assigned to different measures by different categories of Users.

Scores calculated or determined in module step 514 are passed to a module step 146 (FIG. 1). These are scores on individual measures and summary scores that include information from various measures and weights of these component scores. The weights may be default weights selected based on evaluation of reliability, validity, and importance of measures and analysis of what weights consumers give in user testing and observation. Or the weights may be weights from module 512 assigned by Users using sliders or other means to indicate the weight they put on specific measures or measurement dimensions. This use of weights is a key feature of the patent since it allows personalizing. An example of one way for Users to assign weights is the sliders shown in FIG. 14, which is a screen output from the program when the “personalize here” link in the “Overall Quality Score” head is selected. This screen is used as an input of data from the User who weights a variety of quality measures on what is important to the User. The output from the screen is used to recalculate a new set of Quality star scores for the plans. A plurality of sliders, 14 in this example, can be positioned by the User to indicate the importance of a particular possible dimension of quality to the User. When a slider is positioned to the right, the quality score increases, as is shown by the numbers to the left of the bar. For example, this User gave the topic of “customer service and claims handling” a score of 100, which is very important, and a score of zero to the topic of “Members get the tests and treatments they should for diabetes.” Thus, by moving a slider bar, the User can weight different types of quality measures so that the User gets a personalized Overall Quality Score for each plan when the User then clicks on the “Summary” tab. Other quality input means can obviously be used, such as typing in a number next to a topic, or using a drop-down number system.

The overall personalized summary quality score is a key piece of information reported in the All-Plan Decision Support Snapshot 148 and other displays and is passed along to those displays through an output port 514. The output data includes summary scores at more than one level and detailed scores. Summary scores are provided with default weights and after personalization.

With reference to FIG. 11, the part of the Comparison Tool that selects the quality measures and the weights for the quality measures is depicted. Input from a Database 1102 of scores on individual measures or composite measures is sent to a decision step 1104 represented by a decision diamond. In decision step 1104 a decision is made as to whether to use or discard based non-expert opinion. The criteria used vary with the particular embodiment of the Comparison Tool. For example, data from a plan not offered in the geographical area of the User will be discarded. The selected measures from decision diamond 1104 are stored in a standard database 1110. In a display step 1106, the selected measures are sent to a display 1106, such as shown in FIG. 14. From display step 1106, the process proceeds to a step 1108 in which the User defines the weights using the sliders depicted in FIG. 14. Alternatively, a questionnaire can be used, or any other conventional system can be used to assign weights.

The scores of the selected measures are standardized in a step 1114 into quintiles, percentiles, number of standard deviations, or by other known methods. The standardized scores from step 1114 and the weights from step 1108 are sent to step 1116 where the weights are applied by simply multiplying the standardized score with the weight for that measure. Also, an input from step 1112 where experts define the weights is transferred to step 1116. From step 1116, the output is sent to step 1118 where a weighted average composite measure is calculated by summing the weighted measures divided by the sum of the weights. The output from step 1118 is then sent to module 146 (FIG. 1) where it can be used in display 148.

### F. PROVIDER INFORMATION AND DISPLAY

As depicted in FIG. 6, Provider Information Module 128 produces information that allows the User in All-Plan Decision Snapshot Module 148 to see quickly in which available plans their preferred doctors and other health providers participate. It also provides displays that allow Users to find high-quality and/or low-cost doctors and other health care providers.

The central element of these modules is a database 602 that contains information from multiple databases on doctors and other health care providers. Database 602 includes at least some or all of the following information for each health care provider:
names, addresses, phone numbers, DEA numbers, medical school and year of graduation, plan affiliations, whether accepting new patients, license numbers, DOBs, NPI numbers, Tax IDs, SSA numbers, specialties, board certifications, recognitions the provider has received, and other identifiers
   that facilitates matching providers across plans and matching providers to databases of provider quality and cost information, including information on training, hospital affiliations, use of electronic medical records, group practice participation/arrangements, patient experience survey results measures of whether patients get recommended tests and treatments, measures of care coordination, indicators of overuse of procedures, clinical outcomes, patient-reported outcomes, pricing information, and/or other indicators.

Information for database 602 comes from plan provider lists 604 which have information from health care plans themselves, plan provider lists 606 which have information received from other sources, and provider lists 608 which have information from multiple sources with identifiers and quality and cost measures. In addition, the User can also provide information to database 602.

The collected information is provided to a Compilation and Processing step 610 in which there is a process to merge and de-dupe and match providers and data on providers. The information is formatted, categorized, evaluated for reliability and validity, and stored. The identifiers are used to match doctors (and other health care providers) to create a unified, all-plan provider list for the geographic region that is relevant to the User and to attach quality and cost information to the list so that an overall directory is produced with quality and cost information for each provider. Processor step 610 also produces a multi-plan provider list for all plans available to any group of Users; and produces quality, cost, and plan-availability lists for all providers in User's region.

The output from processor step 610 is also provided to a Provider Search and Choose Display step 614, in which a User can look for and choose high-quality, low-cost providers. Directory 612 and Display 614 provide and receive input from the User from input port 616. Through port 616, a mechanism is provided where the User can enter the names of preferred providers as an element of User Characteristics and Preferences Module 122.

Display step 614 provides the User with visible information on the quality and cost of each provider and permits the User to filter, sort, and select providers. Selected Providers can be stored by the User in the preferred provider list of the User, and those selections can be communicated to, and stored by the User Characteristics and Preferences Module 122. Selected Providers can be identified as provider preferences for the Provider Information and Display Module to display the availability of these newly chosen providers in the All-Plan Decision Support Snapshot 148.

Through the process depicted in FIG. 6, there is identified for each available plan which of these preferred providers participate in that plan, and then the provider availability information is communicated to All-Plan Decision Support Snapshot 148, depicted in FIG. 1, so that the User can see for each listed plan which, if any, of the preferred providers of the User participate in that plan.

### G. HEALTH PLAN PRESENTATION AND DISPLAY

As depicted in FIG. 7 in combination with FIG. 1, Presentation Module 146 receives information, for example, from other modules, applies rules on presentation style, grids, data, assembly, maintenance, highlighting, color use, and graphic elements.

Information from other modules enters through an input port 702. This information includes, for example, cost, plan quality, provider availability, and benefits and coverage rules and features. The information is provided to presentation module 146, in which the rules, for example, on presentation style, grids, data, assembly, maintenance, highlighting, color use, graphic elements are applied. All plans and elements are sorted, filtered and selected using conventional methods. The output from presentation module 146 is provided to All-Plan Unified Decision Snapshot module 148. Module 148 lists plans so that the key dimensions of cost, risk in a bad year, plan quality, and doctor availability are shown on a single display or page for a large number of plans that can be easily sorted and filtered. The display lists plans so that multiple plans can be seen at once with plan name and plan type. Module 148 permits the plans to be sorted, filtered, and/or selected based upon previously discussed criteria. For example, the estimated average yearly cost for people like the User, the maximum a User would pay in a year, the overall quality score, which can be personalized by the User, and a list of preferred providers of the User in each plan are displayed and can be used as a basis for sorting.

An example of the display from Module 148 is shown in FIG. 12. This display enables Users, if they wish, to click on various tabs for more detailed displays for more cost information, deductibles/coinsurance/etc., various special coverage features, dental/vision/hearing coverage, plan flexibility, and quality measures.

Module 148 provides 6 categories of information in six databases or tables: a database 708 for more cost information in no-usage, low-usage, and high-usage years and probabilities of such years and/or other cost details; a database 710 for deductibles/coinsurance/etc.; a database 712 for coverage features such as coverage for acupuncture, chiropractic, nursing home, and infertility treatment; a database 714 for dental/vision/hearing coverage; a database 716 for plan flexibility where a plan can state the requirements regarding, for example, referrals, and out-of-network coverage; and a database 718 for quality features that includes detailed quality measures and scores and personalization tools.

### H. EXAMPLE OF A COST CHART

With reference now to the display in FIG. 8, there is a greatly simplified illustration of how the estimated average yearly out-of-pocket cost for people like the User can be calculated. The figure also shows the results of costs out-of-pocket costs that are calculated and added to the premium. The figure is a table having 18 rows (14 numbered rows) and 8 columns. The illustrative table uses a population database or databases of expenses of actual households to fill in each column with expenses for a family profile. This information is used to calculate the likely Out-Of-Pocket (OOP) expenses under each plan for an average of all households of a type like the User. This simplified illustration shows how a calculator can create a few overall expense-level and expense-distribution profiles and assign a probability to each based on the population database(s).

In the example of FIG. 8, the household has a 49 year old husband and wife and the insurance plan illustrated is the ABC Health Plan (a fictitious plan). The ABC Health plan has a $2,500 annual premium after any subsidy for this policyholder (see line 12). It also has a $1,000 deductible and 10% coinsurance on all expenses after the deductible has been reached (see line 14). Finally, this plan has a cap or limit of $8,000 on Out-Of-Pocket (OOP) expense not counting the deductible.

In the table of FIG. 8, the columns are the possible total health care expense profiles considered for people like the User in this illustration. Any number of different expense profiles can be provided for each User (e.g. many thousands or a small number). The profiles and probabilities are based on information on population expenses from one or more data sources (e.g. the Medical Expenditure Panel Survey).

In row 1, there are listed total health care expense levels, from zero to $150,000, each defining a User profile and representing a range of actual expenses of people who can be grouped under that profile. The amounts in this row can be different and there can be many more columns depending on the preferences of the patent implementer. Row 2 provides the calculated probability of the total expense of Row 1 for a person like the User. In particular, in row 2 there is listed the probability of an expense in the range represented by row 1 with the distribution of expense types shown in rows 3-8 for persons/families similar to the User for whom the cost estimate is being prepared.

In rows 3-8, there is a breakdown of how the expenses for each total amount shown in row 1 are distributed among different service or product types. This breakdown can be into a much larger number of service or product types than shown in FIG. 8 at the discretion of the party implementing this patent. And a party implementing the process of the present invention can create multiple columns for each total amount shown in row 1, with a different breakdown of costs among service and product types for each total amount. The illustrative breakdown of expense amounts in FIG. 8 does not show the number or size of product or service units (e.g., office visits) represented by each amount shown in rows 3-8 of a column, but the calculation requires that that information be estimated for each profile.

Row 9 contains the calculated amount the User would have to pay in OOP for the ABC plan if the User falls into the profile in the particular column. These amounts in this illustration vary from $700 OOP for an annual expenditure of $1,000 to $9,000 OOP for an annual expenditure of $150,000. These numbers are calculated based on applying each expense amount in rows 3 through 8 against the plan's cost-sharing rules for that type of expense.

In row 10, the calculated OOP of row 9 for a particular profile is multiplied by the probability of this profile as listed in row 2. As can be seen in the figure, the amounts vary from $112(700*16%) to $360 ($9,000*4%).

In row 11, the weighted average of the total costs for all profiles (i.e. the sum of the amounts in row 10) is calculated to be $2,020.

In row 12, there is listed information of the premium of the User from Premium calculator 402 in FIG. 4. This is based on premiums and subsidies and/or premium-setting and subsidy-setting rules supplied by each plan or by employer, Exchange manager, or other sources. In the example ABC Health plan, this amount is $2,500.

In row 13, the average estimated total cost (premium plus OOP) is listed for households like this one, which amount is $4,520 (Amount in row 11 plus the amount in row 12).

In row 14 of the display, the details of this plan's benefits and coverage terms are stated.

All-Plan Unified Decision Snapshot Module 148 also uses the same types of User profile information that is used to calculate the Estimated Average Yearly Cost for People Like the User to calculate and send to the display modules for each User a dollar estimate of the total cost of the User (premium plus out-of-pocket cost) in an unusually low-usage year and in an unusually high-usage year and the probability of having such a year.

The benefit and coverage information it received and used in FIG. 8 is also used to calculate the maximum out-of-pocket cost the User could experience under each plan. Finally, the Cost for the User module provides the benefit and coverage information to the display module for use in the Deductibles/Coinsurance display, the Coverage Features display, and the Vision/Dental/Hearing display.

### I. EXAMPLE OF SCREEN SHOT OUTPUT

An example of a screen output from All-Plan Unified Decision Snapshot Module 148 is depicted in FIG. 12. The screen shot is generated by Presentation Module 146 as mapped by the program depicted in FIG. 7. In order to get the look and feel of the computer output, FIG. 12 is necessarily reduced in the size of the text. Therefore, a table is presented below to provide the information that might be obscured in the table of FIG. 12:

| | | | D | | | G | | I |
|---|---|---|---|---|---|---|---|---|
| A | B | C | Yr. | E | F | Most | H | Doctor |
| Plan Name | Plan type | Tier | Prem. | OOP | Total | pay | Quality | Name |
| APWU CDHP | CDHP | Silver | 1615 | 385 | 2000 | 9340 | *** | Smith |
| Aetna HDHP | HDHP | Silver | 1655 | 835 | 2490 | 8150 | ** | Smith |
| GEHA HDHP | HDHP | Silver | 1836 | 724 | 2560 | 10930 | *** | Not found |
| AetnaHealth | CDHP | Silver | 2982 | 49 | 3030 | 10650 | ** | Smith |
| Mail Handlers | HDHP | Silver | 2104 | 926 | 3030 | 10450 | * | Smith |
| Kaiser-Std | HMO | Bronze | 1662 | 1368 | 3030 | 10570 | ***** | Unknown |
| CareFirst Blue | HMO | Bronze | 2593 | 1127 | 3720 | 9000 | ** | Smith |
| Hi | | | | | | | | |
| Aetna Open | HMO | Bronze | 2345 | 1395 | 3740 | 12010 | *** | Smith |
| Kaiser-Hi | HMO | Bronze | 2961 | 899 | 3860 | 8770 | ***** | Unknown |
| CareFirst Blue | HMO- | Bronze | 2332 | 1568 | 3900 | 7820 | ** | Not found |
| Std | POS | | | | | | | |
| BlueCross- | PPO | Gold | 2298 | 1652 | 3950 | 7280 | **** | Not found |
| Basic | | | | | | | | |
| GEHA-Std | PPO-fee | Gold | 1695 | 2345 | 4040 | 15340 | ***** | Smith |
| APWU-Hi | PPO-fee | Gold | 2318 | 1792 | 4110 | 8480 | ***** | Not found |
| M.D. IPA | HMO | Bronze | 3317 | 1124 | 4440 | 9510 | ** | Smith |
| NALC | PPO-fee | Gold | 2633 | 2007 | 4640 | 11660 | ***** | Not found |
| SAMBA-Std | PPO-fee | Gold | 2459 | 2231 | 4690 | 17750 | ****/ | Unknown |

The User when presented with the information contained in FIG. 12 can make a reasoned choice about which insurance plan best meets the needs and preferences of the User. The summary rating results displayed in FIG. 12 are generated by the information entered by the User and the processes shown in the other Figures and the rows are ranked or sorted as the User selects. The ranking shown in FIG. 12 is (1) by Cost for Someone Like You, which is the combined total cost including the yearly premium less any government assistance or subsidy plus the health-care cost the User must pay. Alternatively, the results can be ranked by the most a User could pay in a year; by overall quality score, by doctor results (i.e. is a preferred doctor of the User in the plan); by plan type, and by plan name.

The table has 8 columns labeled:

A. Plan Name;

B. Plan Type;

C. Tier;

D. Yearly Premium Minus Any Government Assistance;

E. Health-Care Costs You Pay;

F. Combined Total Cost;

G. Most you Could Pay in a Year;

H. Overall quality Score—Personalize Here;

I. Doctor Result

Above each column are arrows that can be clicked on to sort the table by that column, and above each arrow is a question mark that can be clicked on for more information. There are also 8 tabs that can be clicked on for the User to obtain additional information. These tabs are: Summary (the one selected in FIG. 12); Cost Comparison; Deductibles/Copays/etc.; Coverage Features; Vision/Dental/Hearing (for particular possible coverages); Plan Flexibility; and Quality. Above the tabs are sliders that enable the User to filter the list of plans to see only plans that fall within a selected range on various cost, quality, and other scores/attributes. The display shows the range of values within which plans currently displayed fall and can be filtered. The ranges in the screenshot are three different plan types, quality score values from one star to five stars, an estimated average yearly cost from $2,000 to $7,230; most a User can pay in a year from $7,280 to $27,880; the amounts of deductible from $0 to $4,000; and the yearly premium minus assistance from $1,650 to $6,115.

The numbers in the table are generated by the program as described above in the explanation of the various figures. The actuarially estimated average yearly cost for families like the User are from FIG. 4 and it illustrates the application of the highlighted rules. The most a User could pay in a year is from FIG. 4. The overall quality score with a link to personalize this score is from FIG. 5. And the doctors preferred by the User are from FIG. 6.

### J. CONCLUSION

A particular plan comparison tool has been described for health insurance plans with respect to exemplary conditions and features. It will be obvious to those skilled in the art that many variations and additions can be made to this particularly described presently preferred embodiment of the invention without departing from the underlying principles thereof. However, the scope of the present invention is to be determined only by the following claims.

We claim:

1. A computer implemented system for assisting a User to make an optimum selection from a plurality of health insurance plan offerings, each offering being made by a health insurance offeror, by permitting the simultaneous display of offerings showing estimated average expected cost, including premium and out-of-pocket cost, for Users with characteristics like the characteristics of the User, and showing health insurance plan quality measures, which can include summary quality measures calculated by weighting component measures according to what matters most to the User as indicated by the User, comprising:
a. an input module to receive information on the User;
b. a health insurance offeror module that includes the identity of each offeror and the identity of each offering;
c. a health insurance premium module that includes information about the amount of a premium needed to purchase the health insurance, after possible adjustment for any available subsidy, for each of a plurality of health insurance offerings;
d. an actuarial module for calculating an actuarial estimate of the User's weighted-average expected out-of-pocket cost with the health insurance offering, which out-of-pocket amount is the cost that the User must pay above the premium, said calculation based on an actuarial evaluation of data on the distribution of usage and expenses incurred by populations with characteristics similar to those of the User;
e. a weight module that receives data from a User about personalized weights given to a plurality of quality measures;
f. a health plan quality module to calculate an overall health plan quality score of each offering based on at least two quality measures factoring in the personalized weights; and
g. a display module to display simultaneously a plurality of factors about each health insurance offering.

2. A computer implemented system for assisting a User to make an optimum selection from a plurality of health insurance plan offerings, each offering being made by a health insurance offeror, by permitting the simultaneous display of offerings showing estimated average expected cost, including premium and out-of-pocket cost, for Users with characteristics like the characteristics of the User, and showing whether or not each health insurance plan has in its network a provider the User identifies as a provider the User wants to have available through the plan, comprising:
a. a health insurance input module to receive information on the User;
b. a health insurance offeror module that includes the identity of each offeror and the identity of each offering;
c. a health insurance premium module that includes information about the amount of premium needed to purchase the health insurance, after possible adjustment for any available subsidy, for each of a plurality of health insurance offerings;
d. an actuarial module for calculating an actuarial estimate of the User's weighted-average expected out-of-pocket cost with the health insurance offering, which out-of-pocket amount is the cost that the User must pay above the premium, said calculation based on an actuarial evaluation of data on the distribution of usage and expenses incurred by populations with characteristics similar to those of the User;
e. a health care provider preferences module that enables the User to identify providers that the User wants to be available through a health insurance plan;
f. a display module to display simultaneously in one display for each of a plurality of health insurance plans whether each plan includes a health care provider the User has identified as a provider the User wants available; and
g. a display module to display simultaneously a plurality of factors about each health insurance offering.

3. A computer implemented system for assisting a User to make an optimum selection from a plurality of health insurance plan offerings, each offering being made by a health insurance offeror, by permitting the simultaneous display of offerings showing estimated average expected cost, including premium and out-of-pocket cost, for Users with characteristics like the characteristics of the User, and allowing the out-of-pocket cost estimate to be adjusted for a User's prediction of one or more healthcare conditions, procedures, or products the User expects to have, comprising:
a. an input module to receive information on the User;
b. a health insurance offeror module that includes the identity of each offeror and the identity of each offering;
c. a health insurance premium module that includes information about the amount of a premium needed to purchase the health insurance, after possible adjustment for any available subsidy, for each of a plurality of health insurance offerings;
d. an actuarial module for calculating an actuarial estimate of the User's weighted-average expected out-of-pocket cost with the health insurance offering, which out-of-pocket amount is the cost that the User must pay above the premium, said calculation based on an actuarial evaluation of data on the distribution of usage and expenses incurred by populations with characteristics similar to those of the User;
e. a module allowing the User to enter conditions, procedures, or products the User expects to have;
f. a module allowing the adjustment of the out-of-pocket cost estimate to take into account one or more healthcare conditions, procedures, or products the User expects to have; and
g. a display module to display simultaneously a plurality of factors about each health insurance offering.

4. A computer implemented system for assisting a User to make an optimum selection from a plurality of health insurance plan offerings, each offering being made by a health insurance offeror, by permitting the simultaneous display of offerings showing estimated average expected cost, including premium and out-of-pocket cost, for Users with characteristics like the characteristics of the User, and allowing the premium cost estimate to be adjusted based on input by the User as to a User decision to adjust the amount of premium subsidy to accept, comprising:
a. a health insurance input module to receive information on the User;
b. a health insurance offeror module that includes the identity of each offeror and the identity of each offering;
c. a health insurance premium module that includes information about the amount of premium needed to purchase the health insurance, after possible adjustment for any available subsidy, for each of a plurality of health insurance offerings;
d. an actuarial module for calculating an actuarial estimate of the User's weighted-average expected out-of-pocket cost with the health insurance offering, which out-of-pocket amount is the cost that the User must pay above the premium, said calculation based on an actuarial evaluation of data on the distribution of usage and expenses incurred by populations with characteristics similar to those of the User;
e. a subsidy adjustment module that adjusts the premium the User has to pay based on input by the User as to a User decision to adjust the amount of premium subsidy to accept; and
g. a display module to display simultaneously a plurality of factors about each health insurance offering.

5. A computer implemented system for assisting a User to make an optimum selection from a plurality of health insurance plan offerings, each offering being made by a health insurance offeror, by permitting the simultaneous display of offerings showing estimated average expected cost, including premium and out-of-pocket cost, for Users with characteristics like the characteristics of the User, and allowing the User to filter the health insurance plans displayed by indicating the acceptable range of levels and values of such variables as type of plan, including HMO, PPO, and high-deductible plan; premium; benefit and cost-sharing amounts, including deductible and annual limit; and summary quality score; comprising:
a. an input module to receive information on the User;
b. a health insurance offeror module that includes the identity of each offeror and the identity of each offering;
c. a health insurance premium module that includes information about the amount of a premium needed to purchase the health insurance, after possible adjustment for any available subsidy, for each of a plurality of health insurance offerings;
d. an actuarial module for calculating an actuarial estimate of the User's weighted-average expected out-of-pocket cost with the health insurance offering, which out-of-pocket amount is the cost that the User must pay above the premium, said calculation based on an actuarial evaluation of data on the distribution of usage and expenses incurred by populations with characteristics similar to those of the User;
e. a filter module that enables the User to filter the health insurance plans displayed by indicating the acceptable range of levels and values of such variables as type of plan, including HMO, PPO, and high-deductible plan; premium; benefit and cost-sharing amounts, including deductible and annual limit; and summary quality score; and
f. a display module to display simultaneously a plurality of factors about each health insurance offering.

6. A computer implemented system for assisting a User to make an optimum selection from a plurality of health insurance plan offerings, each offering being made by a health insurance offeror, by permitting the simultaneous display of offerings showing estimated average expected cost, including premium and out-of-pocket cost, for Users with characteristics like the characteristics of the User, and allowing the User to search a list of providers practicing in the User's geographic region to identify which providers have been recognized for the quality and/or efficiency of the care they provide and which health plans those providers participate in, comprising:
a. a health insurance input module to receive information on the User;
b. a health insurance offeror module that includes the identity of each offeror and the identity of each offering;
c. a health insurance premium module that includes information about the amount of premium needed to purchase the health insurance, after possible adjustment for any available subsidy, for each of a plurality of health insurance offerings;
d. an actuarial module for calculating an actuarial estimate of the User's weighted-average expected out-of-pocket cost with the health insurance offering, which out-of-pocket amount is the cost that the User must pay above the premium, said calculation based on an actuarial evaluation of data on the distribution of usage and expenses incurred by populations with characteristics similar to those of the User;
e. a module listing providers in the User's geographic area and showing whether or not each provider has received at least one type of recognition or score for the quality and efficiency of care the provider delivers and which health insurance plans each provider participates in; and
f. a display module to display simultaneously a plurality of factors about each health insurance offering.

7. A computer implemented system for assisting a User to make an optimum selection from a plurality of health insurance plan offerings, each offering being made by a health insurance offeror, by permitting the simultaneous display of offerings showing estimated average expected cost, including premium and out-of-pocket cost, for Users with characteristics like the characteristics of the User, and allowing the User to learn more about the displayed information and about health insurance by listening to and/or watching audio and/or video clips, comprising:
a. a health insurance input module to receive information on the User;
b. a health insurance offeror module that includes the identity of each offeror and the identity of each offering;
c. a health insurance premium module that includes information about the amount of premium needed to purchase the health insurance, after possible adjustment for any available subsidy, for each of a plurality of health insurance offerings;
d. an actuarial module for calculating an actuarial estimate of the User's weighted-average expected out-of-pocket cost with the health insurance offering, which out-of-pocket amount is the cost that the User must pay above the premium, said calculation based on an actuarial evaluation of data on the distribution of usage and expenses incurred by populations with characteristics similar to those of the User;
e. a module allowing the User to learn more about the displayed information and about health insurance and available plans by listening to and/or watching audio and/or video clips with information about health insurance and about available plans; and
g. a display module to display simultaneously a plurality of factors about each health insurance offering.

8. A computer implemented system for assisting a User to make an optimum selection from a plurality of health insurance plan offerings, each offering being made by a health insurance offeror, said system comprising a display permitting the simultaneous display of offerings; and a health plan quality module that includes an input device that a User uses to assign weights to quality measures and wherein said quality module calculates a summary quality score based on a score (or rating) and the User-assigned weight for a plurality of health care measures.

9. The computer implemented system for health care plans as claimed in claim 8, wherein said input device comprises a display containing a slider bar that can be positioned by a User for each measure to which a quality score can be assigned.

10. A computer implemented system for assisting a User to make an optimum selection from a plurality of health insurance plan offerings, each offering being made by a health insurance offeror, by permitting the simultaneous display of offerings wherein a health care provider preferences module enables the User to identify providers that the User wants to be available through a health insurance plan and a display module shows for each plan whether or not the User-preferred provider is available through the plan.

11. A computer implemented method for assisting a User to make an optimum selection from a plurality of health insurance offerings by simultaneously providing a User with a number of health insurance factors calculated or provided for each health insurance offering, said method comprising:
a. receiving personal data about a User;
b. providing the identity of a health insurance offeror and the identity of the offering that the offeror offers;
c. obtaining information about the amount of a premium needed to purchase a health insurance offering for each of a plurality of health insurance offerings;
d. analyzing data on the distribution of health care usage and expenses incurred by populations with characteristics like the characteristics of the User and, based on the analyzed data, calculating an estimate of the weighted-average expected out-of-pocket costs to be paid with the offering for expenses not included in the premium, by entities with characteristics like the characteristics of the User;
e. receiving information from a User about personalized weights given by the User to a plurality of measures of health plan quality; and
f. calculating an overall score of each health insurance offering based on at least two health plan quality measures weighted by the personalized weights; and
g. simultaneously displaying a plurality of factors about each health insurance offering based on the personal data of the User, including a calculated personalized overall health plan quality score.

12. A computer implemented method for assisting a User to make an optimum selection from a plurality of health insurance offerings by simultaneously providing a User with a number of health insurance factors calculated or provided for each health insurance offering, said method comprising:
a. receiving personal data about a User;
b. providing the identity of a health insurance offeror and the identity of the offering that the offeror offers;
c. obtaining information about the amount of a premium needed to purchase a health insurance offering for each of a plurality of health insurance offerings;
d. analyzing data on the distribution of health care usage and expenses incurred by populations with characteristics like the characteristics of the User and, based on the analyzed data, calculating an estimate of the weighted-average expected out-of-pocket costs to be paid with the offering for expenses not included in the premium, by entities with characteristics like the characteristics of the User;
e. Receiving input from the User identifying a health care provider the User wants to have available through a health insurance plan;
f. displaying a plurality of health plans showing in which of this plurality of plans a User-identified provider participates; and
g. simultaneously displaying a plurality of factors about each health insurance offering based on the personal data of the User including showing in which of this plurality of plans a selected provider participates.

13. A computer implemented method for assisting a User to make an optimum selection from a plurality of health insurance offerings by simultaneously providing a User with a number of health insurance factors calculated or provided for each health insurance offering, said method comprising:
a. receiving personal data about a User;
b. providing the identity of a health insurance offeror and the identity of the offering that the offeror offers;
c. obtaining information about the amount of a premium needed to purchase a health insurance offering for each of a plurality of health insurance offerings;
d. analyzing data on the distribution of health care usage and expenses incurred by populations with characteristics like the characteristics of the User and, based on the analyzed data, calculating an estimate of the weighted-average expected out-of-pocket costs to be paid with the offering for expenses not included in the premium, by entities with characteristics like the characteristics of the User;
e. receiving input from the user as to conditions, procedures, or products the User expects to have;
f. adjusting the out-of-pocket cost estimate to take into account one or more healthcare conditions, procedures, or products the User expects to have; and
g. simultaneously displaying a plurality of factors about each health insurance plan offering based on personal data of the User including showing an out-of-pocket cost estimate that takes into account one or more healthcare conditions, procedures, or products the User expects to have.

14. A computer implemented method for assisting a User to make an optimum selection from a plurality of health insurance offerings by simultaneously providing a User with a number of health insurance factors calculated or provided for each health insurance offering, said method comprising:
a. receiving personal data about a User;
b. providing the identity of a health insurance offeror and the identity of the offering that the offeror offers;
c. obtaining information about the amount of a premium needed to purchase a health insurance offering for each of a plurality of health insurance offerings;
d. analyzing data on the distribution of health care usage and expenses incurred by populations with characteristics like the characteristics of the User and, based on the analyzed data, calculating an estimate of the weighted-average expected out-of-pocket costs to be paid with the offering for expenses not included in the premium, by entities with characteristics like the characteristics of the User;
e. receiving input from the User as to a User decision to adjust the amount of premium subsidy to accept;
f. displaying a plurality of health insurance plans showing the premium after adjustment for the adjusted subsidy amount the User decides to accept; and
g. simultaneously displaying a plurality of factors about each health insurance offering based on personal data of the User including showing a premium after adjustment for the adjusted subsidy amount the User decides to accept.

15. A computer implemented method for assisting a User to make an optimum selection from a plurality of health insurance offerings by simultaneously providing a User with a number of health insurance factors calculated or provided for each health insurance offering, said method comprising:
a. receiving personal data about a User;
b. providing the identity of a health insurance offeror and the identity of the offering that the offeror offers;
c. obtaining information about the amount of a premium needed to purchase a health insurance offering for each of a plurality of health insurance offerings;
d. analyzing data on the distribution of health care usage and expenses incurred by populations with characteristics like the characteristics of the User and, based on the analyzed data, calculating an estimate of the weighted-average expected out-of-pocket costs to be paid with the offering for expenses not included in the premium, by entities with characteristics like the characteristics of the User;
e. receiving input from the User as to how the User wants to limit the number of plans displayed by displaying only plans that have levels and values that are within a User-specified range of levels and values for such variables as type of plan, including HMO, PPO, and high-deductible plan; premium; benefit and cost-sharing amounts, including deductible and annual limit; and summary quality score; and
f. simultaneously displaying a plurality of factors about each health insurance plan including only those plans that have levels and values that are within a User-specified range of levels and values for such variables as type of plan, including HMO, PPO, and high-deductible plan; premium; benefit and cost-sharing amounts, including deductible and annual limit; and summary quality score.

16. A computer implemented method for assisting a User to make an optimum selection from a plurality of health insurance offerings by simultaneously providing a User with a number of health insurance factors calculated or provided for each health insurance offering, said method comprising:
a. receiving personal data about a User;
b. providing the identity of a health insurance offeror and the identity of the offering that the offeror offers;
c. obtaining information about the amount of a premium needed to purchase a health insurance offering for each of a plurality of health insurance offerings;
d. analyzing data on the distribution of health care usage and expenses incurred by populations with characteristics like the characteristics of the User and, based on the analyzed data, calculating an estimate of the weighted-average expected out-of-pocket costs to be paid with the offering for expenses not included in the premium, by entities with characteristics like the characteristics of the User; and
e. listing providers in the User's geographic area and showing whether or not each provider has received at least one type of recognition or score for the quality and efficiency of care the provider delivers and which health insurance plans each provider participates in.

17. A computer implemented method for assisting a User to make an optimum selection from a plurality of health insurance offerings by simultaneously providing a User with a number of health insurance factors calculated or provided for each health insurance offering, said method comprising:
a. receiving personal data about a User;
b. providing the identity of a health insurance offeror and the identity of the offering that the offeror offers;
c. obtaining information about the amount of a premium needed to purchase a health insurance offering for each of a plurality of health insurance offerings;
d. analyzing data on the distribution of health care usage and expenses incurred by populations with characteristics like the characteristics of the User and, based on the analyzed data, calculating an estimate of the weighted-average expected out-of-pocket costs to be paid with the offering for expenses not included in the premium, by entities with characteristics like the characteristics of the User;
e. displaying links or symbols that the User can activate to learn about health insurance and available plans by listening to and/or watching audio and/or video clips with information about health insurance and about available plans; and
f. simultaneously displaying a plurality of health insurance plans including in said display links or symbols that the User can activate to learn about health insurance and available plans by listening to and/or watching audio and/or video clips with information about health insurance and about available plans.

18. A computer-readable storage device comprising software to produce a display for one or more health insurance plans for a User, based on information on User characteristics entered by or for the User, comprising a display of:
a. how much the User will have to pay for premiums to purchase health insurance under each plan;
b. the average cost populations with characteristics like the User will have to pay with each plan for health care expenses not covered by the plan (called out-of-pocket costs, or OOP), based on analysis of data on the distribution of usage and expenses incurred by populations of individuals and/or households with characteristics like those of the User, wherein said characteristics include age, and family composition;
c. for health plans for which such cost information is displayed, which of various providers selected by the User participates in each listed plan.

19. A computer-readable storage device comprising software to produce a display for one or more health insurance plans for a User, based on information on User characteristics entered by or for the User, comprising a display of:
a. how much the User will have to pay for premiums to purchase health insurance under each plan;
b. the average cost populations with characteristics like the User will have to pay with each plan for health care expenses not covered by the plan (called out-of-pocket costs, or OOP), based on analysis of data on the distribution of usage and expenses incurred by populations of individuals and/or households with characteristics like those of the User, wherein said characteristics include age, and family composition; and
c. for health plans for which such cost information is displayed, an overall score for plan quality taking into account two or more quality measures and allowing the User to give personalized weights to these measures for calculation of the overall score.

20. A computer-readable storage device comprising software to produce a display for one or more health insurance plans for a User, based on information on User characteristics entered by or for the User, comprising a display of:
a. how much the User will have to pay for premiums to purchase health insurance under each plan;
b. the average cost populations with characteristics like the User will have to pay with each plan for health care expenses not covered by the plan (called out-of-pocket costs, or OOP), based on analysis of data on the distribution of usage and expenses incurred by populations of individuals and/or households with characteristics like those of the User, wherein said characteristics include age, and family composition; and
c. for health plans for which such cost information is displayed, an out-of-pocket cost estimate adjusted for a User's prediction of one or more healthcare conditions, procedures, or products the User expects to have.

21. A computer-readable storage device comprising software to produce a display for one or more health insurance plans for a User, based on information on User characteristics entered by or for the User, comprising a display of:
a. how much the User will have to pay for premiums to purchase health insurance under each plan;
b. the average cost populations with characteristics like the User will have to pay with each plan for health care expenses not covered by the plan (called out-of-pocket costs, or OOP), based on analysis of data on the distribution of usage and expenses incurred by populations of individuals and/or households with characteristics like those of the User, wherein said characteristics include age, and family composition; and
c. for health plans for which such cost information is displayed, a premium estimate that is adjusted based on input by the User as to a User decision to adjust the amount of premium subsidy to accept.

22. A computer-readable storage device comprising software to produce a display for one or more health insurance plans for a User, based on information on User characteristics entered by or for the User, comprising a display of:
a. how much the User will have to pay for premiums to purchase health insurance under each plan;
b. the average cost populations with characteristics like the User will have to pay with each plan for health care expenses not covered by the plan (called out-of-pocket costs, or OOP), based on analysis of data on the distribution of usage and expenses incurred by populations of individuals and/or households with characteristics like those of the User, wherein said characteristics include age, and family composition; and
c. for health plans for which such cost information is displayed, simultaneously displaying a plurality of factors about each health insurance plan filtered to include only those plans that have levels and values that are within a User-specified range of levels and values for such variables as type of plan, including HMO, PPO, and high-deductible plan; premium; benefit and cost-sharing amounts, including deductible and annual limit; and summary quality score.

23. A computer-readable storage device comprising software to produce a display for one or more health insurance plans for a User, based on information on User characteristics entered by or for the User, comprising a display of:
a. how much the User will have to pay for premiums to purchase health insurance under each plan;
b. the average cost populations with characteristics like the User will have to pay with each plan for health care expenses not covered by the plan (called out-of-pocket costs, or OOP), based on analysis of data on the distribution of usage and expenses incurred by populations of individuals and/or households with characteristics like those of the User, wherein said characteristics include age, and family composition; and
c. allowing the User to search a list of providers practicing in the User's geographic region to identify which providers have been recognized for the quality and/or efficiency of the care they provide.

24. A computer-readable storage device comprising software to produce a display for one or more health insurance plans for a User, based on information on User characteristics entered by or for the User, comprising a display of:
a. how much the User will have to pay for premiums to purchase health insurance under each plan;
b. the average cost populations with characteristics like the User will have to pay with each plan for health care expenses not covered by the plan (called out-of-pocket costs, or OOP), based on analysis of data on the distribution of usage and expenses incurred by populations of individuals and/or households with characteristics like those of the User, wherein said characteristics include age, and family composition; and
c. enabling the User to learn more about the displayed information and about health insurance by clicking on icons that activate audio and/or video clips that the User can listen to and/or watch.

25. The computer-readable storage device of claim 18, allowing the user to learn more about the displayed information and about health insurance by reading explanations and advice on health insurance.

26. The computer-readable storage device of claim 18, and further comprising allowing the User, for each health insurance plan displayed, to drill down for a display of additional estimates of what the out-of-pocket costs of a User would be in illustrative years in which the User had unusually high health care usage or unusually low health care usage and the probability of having such years.

27. The computer-readable storage device of claim 18, and further comprising allowing the User, for each health insurance plan displayed, to drill down for a display of additional information on coverage terms (deductibles, co-pays, coinsurance, out-of-pocket limits, etc.), coverage for alternative therapies (e.g., acupuncture), flexibility for plan members to use out-of-network providers, and/or coverage for dental, vision, or hearing care.

28. The computer-readable storage device of claim 18, and further comprising allowing the user to sort plans in the display according to values of factors including premium, and overall quality score.

29. A computer-readable storage device comprising software to produce a display for one or more health insurance plans for a User, based on information on User characteristics entered by or for the User, comprising a display of a summary plan quality score, based on combining scores of individual measures weighted according to weights assigned by the User assigns to each measure or measure dimension.

30. A computer-readable storage device comprising software to produce a display for a plurality of health insurance plans for a User, based on information on User characteristics entered by or for the User, showing for each of a plurality of health insurance plans which plans have available a provider identified by the User as a provider that the User wants to have available through the plan.
